(19) United States
(12) Patent Application Publication
(10) Pub. No.: US 2011/0265093 A1
(43) Pub. Date: Oct. 27, 2011

(54) Computer System and Program Product

(75) Inventors: Takashi NAKAHARA, Hitachi-shi (JP); Tadashi Kamiwaki, Naka-gun (JP); Shigeru Matsuo, Hitachinaka-shi (JP)

(73) Assignee: Hitachi, Ltd., Tokyo (JP)

(21) Appl. No.: 13/094,306

(22) Filed: Apr. 26, 2011

(30) Foreign Application Priority Data
Apr. 27, 2010 (JP) 2010-102612

(51) Int. Cl. G06F 9/50

(52) U.S. Cl. 718/104

(57) ABSTRACT

A computer system includes a plurality of processors, a shared resource being used by the processors, and a storage unit in which management information corresponding to the shared resource is stored. The management information includes a semaphore for each OS managing a task which runs on the processors, a queue in which information for specifying a processor which has requested acquisition of the shared resource is stored in series, and a resource counter indicating a remaining number of the shared resources which can be acquired. Each of the processors includes a counter obtaining section that obtains a value of the resource counter, an acquisition decision-making section that makes a decision as to whether or not the shared resource can be acquired, and a resource acquiring section that stores information for specifying the processor in the queue if decided that it can not be acquired.

### INCORPORATION BY REFERENCE

The disclosure of the following priority application is herein incorporated by reference: Japanese Patent Application No. 2010-102612 (filed Apr. 27, 2010).

### BACKGROUND OF THE INVENTION

1. Field of the Invention

The present invention relates to a computer system and a program product used therefor.

2. Description of Related Art

There is a growing need for simultaneous processing of multiple functions in embedded devices such as navigation devices and in computer systems such as personal computers. For this reason, CPUs mounted on those devices and systems have recently been moving from those of single core to tightly-coupled multiprocessors called multi-core.

There are two types of multiprocessors in terms of usage, i.e., symmetric multiprocessors (SMP) and asymmetric multiprocessors (AMP). A symmetric multiprocessor manages all CPU cores (hereinafter referred to as cores) on one OS, and an asymmetric multiprocessor manages cores on a plurality of OSs. Personal computers use an SMP-compatible OS so as to control all the cores, and some embedded devices use an SMP-compatible OS.

However, it is necessary for an existing software asset to be ported to an SMP-compatible OS so as to operate on a symmetric multiprocessor, and thus a failure occurring on the OS will affect the whole system. In addition, some existing software assets operate only on single core-compatible OSs. Therefore, in order to solve the above two problems, an asymmetric multiprocessor is applied to an embedded system, so that one core is assigned for one function and one OS is assigned for one core. Inter-core exclusive control of resources such as an SRAM and a DRAM will be targeted in the above system.

In Patent Literature 1, a semaphore of each OS is stored in a shared memory and cooperates with one another so as to perform inter-processor exclusive control of a resource. In Patent Literature 2, a lock variable in a shared memory is used so as to perform inter-processor exclusive control of a resource.

Patent Literature 1: Japanese Laid-Open Patent Publication No. H7-160645

Patent Literature 2: Japanese Laid-Open Patent Publication No. 2003-345614

The exclusive control method in Patent Literature 1 requires to perform semaphore acquisition system calls of a processor OS and another processor OS and access to a shared memory each time so as to acquire a resource managed by another processor. As a result, it takes a long time before resource acquisition, thereby causing a problem of reduction in processing efficiency of the overall computer system.

The exclusive control method in Patent Literature 2 executes loop processing in a processor during acquisition latency for a lock variable in a shared memory, thereby causing a problem of reduction in processing efficiency of the overall computer system. In addition, power consumption is high during the loop processing.

### SUMMARY OF THE INVENTION

A computer system according to a 1st aspect of the present invention includes a plurality of processors each executing an individual OS, a shared resource being used by the plurality of processors, and a storage unit in which management information corresponding to the shared resource is stored. In this computer system, the management information includes a semaphore for each OS managing a task which runs on the plurality of processors, a queue in which information for specifying a processor which has requested acquisition of the shared resource is stored in series, and a resource counter indicating a remaining number of the shared resources which can be acquired. In addition, each of the plurality of processors includes a counter obtaining section that obtains a value of the resource counter included in the management information corresponding to the shared resource to be acquired for processing the task, an acquisition decision-making section that makes a decision as to whether or not the shared resource can be acquired based upon the value of the resource counter obtained by the counter obtaining section, and a resource acquiring section that acquires the shared resource and decrements the value of the resource counter of the corresponding management information if the acquisition decision-making section makes a decision that the shared resource can be acquired, and that stores information for specifying the processor in the queue of the management information corresponding to the shared resource and sets a task to be processed by the processor in a waiting state if the acquisition decision-making section makes a decision that the shared resource can not be acquired.

According to a 2nd aspect of the present invention, in the computer system of the 1st aspect, it is desirable that each of the plurality of processors further includes an empty queue decision-making section that makes a decision as to whether or not the queue of the shared resource is empty upon releasing the shared resource having been acquired, and a resource releasing section that increments the value of the resource counter of the shared resource and releases the shared resource if the empty queue decision-making section makes a decision that the queue of the shared resource is empty, and that causes a processor to be specified by the information stored in the queue to acquire the shared resource and sets a task on the processor in an execution state if the empty queue decision-making section makes a decision that the queue of the shared resource is not empty.

According to a 3rd aspect of the present invention, in the computer system of the 1st aspect, at least one of the plurality of processors may further include a management information generating section that generates the management information, and a management information storage section that stores the management information generated by the management information generating section in the storage unit.

According to a 4th aspect of the present invention, in the computer system of the 2nd aspect, at least one of the plurality of processors may further include a management information generating section that generates the management information, and a management information storage section that stores the management information generated by the management information generating section in the storage unit. In this computer system, it is desirable that the management information generating section generates the management information in which a semaphore counter included in the semaphore for each OS is set to zero; and, if a decision is made that the queue is not empty, the resource releasing section increments a semaphore counter corresponding to a processor to be specified by the information stored in the queue so as to cause the processor to acquire the shared resource and sets a task on the processor in an execution state.

According to a 5th aspect of the present invention, in the computer system of any one of the 1st through 4th aspects, the management information may further include a lock variable, and each of the plurality of processors may further include a lock decision-making section that makes a decision as to whether or not the management information can be read based upon the lock variable when obtaining the management information from the storage unit. In this computer system, in is desirable that the counter obtaining section obtains the value of the resource counter included in the management information when the lock decision-making section makes a decision that the management information can be read.

According to a 6th aspect of the present invention, in the computer system of the 2nd aspect the management information may further include a lock variable, and each of the plurality of processors may further include a lock decision-making section that makes a decision as to whether or not the management information can be read based upon the lock variable when obtaining the management information from the storage unit. In this computer system, it is desirable that the empty queue decision-making section makes a decision as to whether or not the queue is empty in the management information corresponding to the shared resource acquired by the resource acquisition means when the lock decision-making section makes a decision that the management information can be read.

According to a 7th aspect of the present invention, in the computer system of any one of the 1st through 7th aspects, the management information may further include priority order information that defines for each processor a priority order to acquire the shared resource and waiting order determination method information that defines a method for the resource acquisition means to store the information in the queue, and the resource acquiring section may make a decision on a position in the queue in which the information is stored based upon the waiting order determination method information and the priority order information.

According to an 8th aspect of the present invention, in the computer system of the 7th aspect, it is preferable that the resource acquiring section stores the information in the queue on a first come, first served basis or in order according to the priority order based upon the waiting order determination method information and the priority order information.

According to a 9th aspect of the present invention, in the computer system of the 7th aspect, the management information may further include a predetermined priority order threshold value, and the resource acquiring section may make a decision on a position in the queue in which the information is stored based upon the waiting order determination method information, the priority order information, and the priority order threshold value.

According to a 10th aspect of the present invention, in the computer system of the 9th aspect, it is desirable that the resource acquiring section stores the information in the queue on a first come, first served basis or in order according to the priority order based upon the waiting order determination method information, the priority order information, and the priority order threshold value.

According to an 11th aspect of the present invention, in the computer system of any one of the 1st through 10th aspects, the storage unit can further store an OS system call being commonly accessible among the plurality of processors and a memory address indicating a position of the OS system call, and the processor cam execute the OS system call based upon the memory address.

A program product according to a 12th aspect of the present invention has a program to cause, when executed by any one of the plurality of processors of the computer system according to the 1st aspect, the one of the plurality of processors to function as the counter obtaining section, the acquisition decision-making section, and the resource acquiring section.

A program product according to a 13th aspect of the present invention has a program to cause, when executed by any one of the plurality of processors of the computer system according to the 2nd aspect, the one of the plurality of processors to function as the counter obtaining section, the acquisition decision-making section, the resource acquiring section, the queue information obtaining section, the empty queue decision-making section, and the resource releasing section.

A program product according to a 14th aspect of the present invention has a program to cause, when executed by any one of the plurality of processors of the computer system according to the 3rd aspect, the one of the plurality of processors to function as the counter obtaining section, the acquisition decision-making section, the resource acquiring section, the queue information obtaining section, the empty queue decision-making section, the resource releasing section, the management information generating section, and the management information storage section.

The present invention provides management information for each shared resource. This allows a decision as to whether or not a shared resource is acquired to be made immediately based upon the management information, thereby reducing time before resource acquisition. In addition, when a shared resource has not been acquired, the flow of control immediately enters a waiting state without entering loop processing, thereby not interfering with a progress of other processing in an executable state. This prevents occurrence of a problem of reduction in processing efficiency of the overall computer system due to exclusive control in relation to acquisition of a shared resource.

### BRIEF DESCRIPTION OF THE DRAWINGS

FIG. 1 is an illustrative diagram showing an example of a hardware configuration of a computer system according to an embodiment of the present invention.

FIG. 2 is an illustrative diagram showing an example of hierarchies of hardware and software according to an embodiment of the present invention.

FIG. 3 is an illustrative diagram showing an example of an application program structure according to an embodiment of the present invention.

FIG. 4 is an illustrative diagram showing an example of functions of an OS according to an embodiment of the present invention.

FIG. 5 is an illustrative diagram showing an example of a set of OS system calls according to an embodiment of the present invention.

FIG. 6 is an illustrative diagram showing a scheme of an exclusive control method in relation to acquisition of a shared resource according to an embodiment of the present invention.

FIG. 7 is an illustrative diagram showing an example of a relationship between a core number queue and a semaphore queue of the present invention.

FIG. 8 is an illustrative diagram showing an example of a set of OS system call pointes according to an embodiment of the present invention.

FIG. 9 is an illustrative diagram showing an example of a set of inter-core shared functions according to an embodiment of the present invention.

FIG. 10A and FIG. 10B are illustrative diagrams showing an example of core number queues according to an embodiment of the present invention.

FIG. 11 is an illustrative diagram showing an example of inter-core priority information according to an embodiment of the present invention.

FIG. 12 is an illustrative diagram showing an example of an initialization procedure necessary to generate inter-core resource management information according to an embodiment of the present invention.

FIG. 13 is an illustrative diagram showing an example of the process flow of each core OS system call registration function according to an embodiment of the present invention.

FIG. 14 is an illustrative diagram showing an example of the process flow of a resource management information generation function according to an embodiment of the present invention.

FIG. 15 is an illustrative diagram showing an example of the process flow of a resource acquisition function according to an embodiment of the present invention.

FIG. 16 is an illustrative diagram showing an example of the process flow of a resource release function according to an embodiment of the present invention.

FIG. 17 is an illustrative diagram showing an example of the process flow of processing of a resource acquisition function according to an embodiment of the present invention when there is no other task in an executable state.

FIG. 18 is an illustrative diagram showing an example of a time chart in relation to inter-core resource management information and task states according to an embodiment of the present invention.

FIG. 19 is an illustrative diagram showing an example of the process flow in relation to initial value setting of inter-core resource management information in a resource management information generation function of an embodiment of the present invention.

FIG. 20 is an illustrative diagram showing an example of the process flow in relation to setting of inter-core priority information in the process flow in relation to initial value setting of inter-core resource management information according to an embodiment of the present invention.

FIG. 21 is an illustrative diagram showing an example of the process flow in relation to an exclusive control method to be executed when a value of an inter-core resource counter is obtained in processing of a resource acquisition function according to an embodiment of the present invention.

FIG. 22 is an illustrative diagram showing an example of the process flow to be executed when a state of a core number queue is obtained in processing of a resource release function according to an embodiment of the present invention.

FIG. 23 is an illustrative diagram showing an example of a core number queue according to an embodiment of the present invention.

FIG. 24 is an illustrative diagram showing an example of inter-core priority information according to an embodiment of the present invention.

FIG. 25 is an illustrative diagram showing an example of a waiting order determination method of inter-core priority information according to an embodiment of the present invention.

FIG. 26 is an illustrative diagram showing an example of a waiting order determination method of inter-core priority information according to an embodiment of the present invention.

FIG. 27 is an illustrative diagram showing an example of a waiting order determination method of inter-core priority information according to an embodiment of the present invention.

FIG. 28 is an illustrative diagram showing an example of a waiting order determination method of inter-core priority information according to an embodiment of the present invention.

FIG. 29 is an illustrative diagram showing an example of the process flow of processing to store a core number into a core number queue in a resource acquisition function of an embodiment of the present invention.

FIG. 30 is an illustrative diagram showing an example of hierarchies of hardware and software with respect to exclusive control in relation to acquisition of an existing inter-core shared resource.

FIG. 31 is an illustrative diagram showing an example of the process flow in relation to acquisition of a conventionally known inter-core shared resource.

FIG. 32 is an illustrative diagram showing a variation of a hardware configuration of the computer system of an embodiment of the present invention.

FIG. 33 is an illustrative diagram showing a variation of hierarchies of hardware and software of an embodiment of the present invention.

FIG. 34 is an illustration showing provision of a program to a computer system.

### DESCRIPTION OF PREFERRED EMBODIMENTS

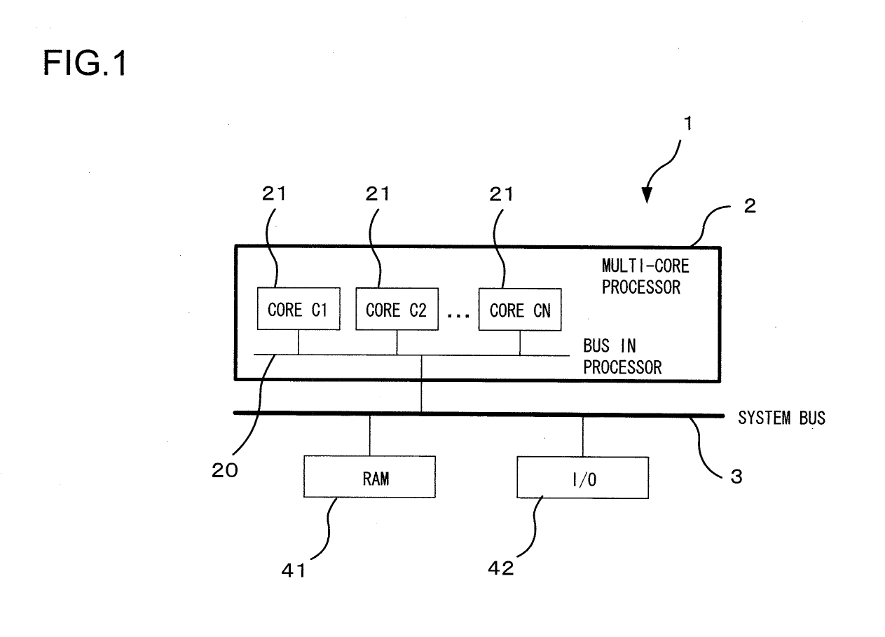

FIG. 1 shows an example of a hardware configuration of a computer system according to the present embodiment. A computer system 1 includes a multi-core processor 2, a system bus 3, a RAM 41, an I/O 42, and the like.

The multi-core processor 2 performs data communication with the RAM 41 and the I/O 42 through the system bus 3 so as to perform calculation processing as reading data from a device connected to the I/O 42 and temporarily storing the data into the RAM 41 and return a calculation result to the device connected to the I/O 42. The multi-core processor 2 connects a plurality of cores 21 with a bus 20 in the processor and has an inter-core interrupt function which enables a hardware interrupt from one core of the cores 21 to another core thereof. In addition, each of the cores has a power saving function to enter a standby state while calculation processing is not being performed.

The I/O 42 is an input/output interface of the multi-core processor 2. The multi-core processor 2 transmits and receives data through the I/O 42 with input/output devices such as a touch screen, a keyboard, a display, and a variety of disk drives.

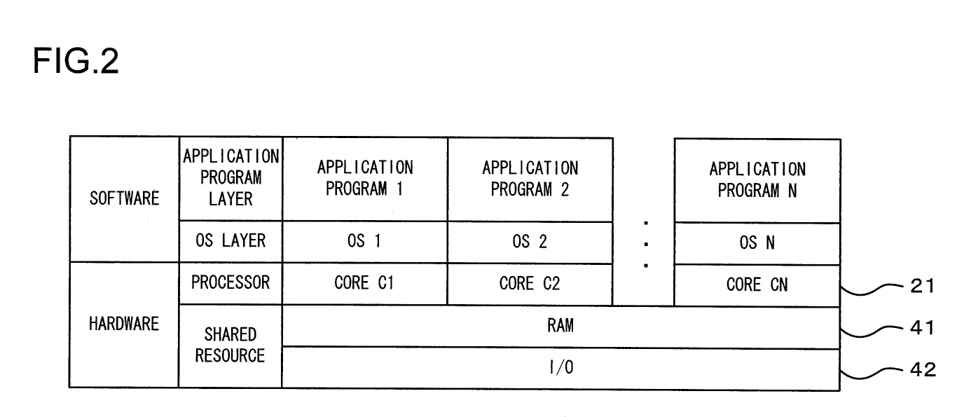

FIG. 2 shows hierarchies of hardware and software of the present embodiment. In the present embodiment, an application program runs on an OS mounted on each of the cores 21 of the multi-core processor 2. In addition, the cores 21 of the multi-core processor 2 share the RAM 41, the I/O 42, and the like. The RAM 41, the I/O 42, and the like are hereinafter referred to as inter-core shared resources.

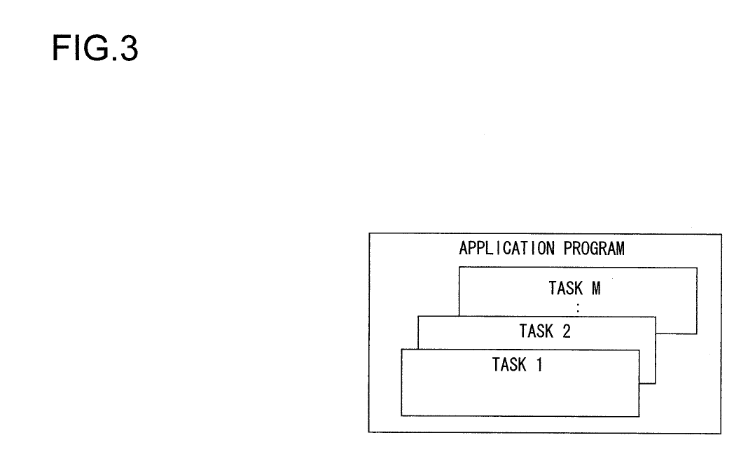

FIG. 3 shows the structure of an application program according to the present embodiment. The application program is composed of a plurality of operation units called tasks. The execution order of the tasks is controlled by the OS. The tasks assume the following three states, i.e. an execution state, an executable state, and a waiting state. The execution state refers to a state in which the cores execute processing of a task. The executable state refers to a state in which even though the cores can execute the processing, they do not execute it because they are occupied by another task. The waiting state refers to a state in which processing is not executed because of resource acquisition queuing or the like.

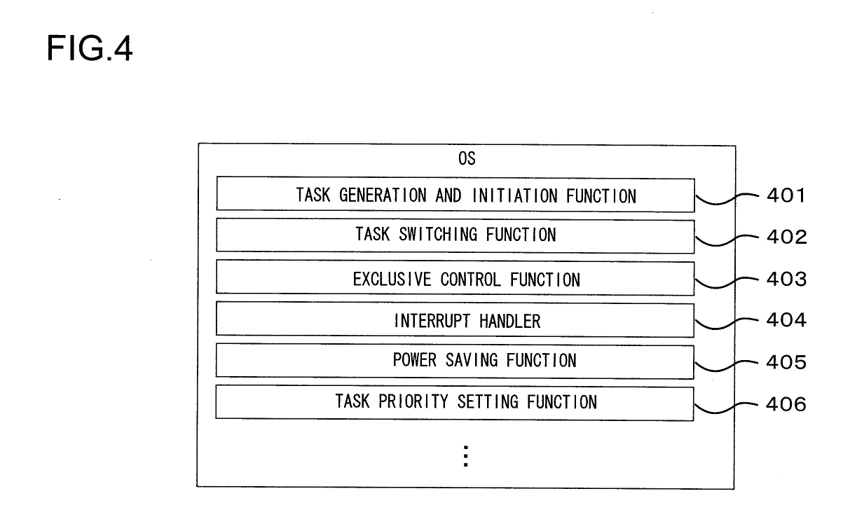

FIG. 4 shows functions of the OS in the present embodiment. In the present embodiment, the OS includes at least a task generation and initiation function 401, a task switching function 402, an exclusive control function 403, an interrupt handler 404, a power saving function 405, and a task priority setting function 406.

The task generation and initiation function 401 is a function with which the OS generates a task and the generated task is initiated and enters the execution state or the executable state.

The task switching function 402 is a function with which, based upon priorities set for the tasks and the state of each of the tasks, the tasks to be executed by the OS are switched. Where a plurality of tasks have been initiated and there is a task in the execution state, when a task in the executable state, which has a higher priority than the task in the execution state, is initiated, the task in the execution state is stopped and the task of the higher priority is executed. In addition, if the task in the execution state enters the waiting state because it assumes the resource acquisition queuing or the like, the task switching function 402 switches the task from the execution state to the waiting state, stops the task, causes another task in the executable state to enter the execution state, and causes the cores 21 to perform the processing.

The exclusive control function 403 is a function with which a semaphore is used to exclusively control acquisition of a shared resource by a plurality of tasks or application programs. The semaphore is composed of a semaphore counter and a task queue. The semaphore counter, which is an integer variable, indicates the number of available shared resources. When the number of tasks more than the value of the semaphore counter attempt to use a shared resource, some of the tasks wait for acquisition of the shared resource and are stored in a semaphore queue.

The interrupt handler 404 has a function to execute processing initiated by a hardware interrupt from the I/O 42 or an inter-core interrupt from another core.

The power saving function 405 is a function to set a core in power saving mode.

The task priority setting function 406 is a function to set a priority order in relation to task execution.

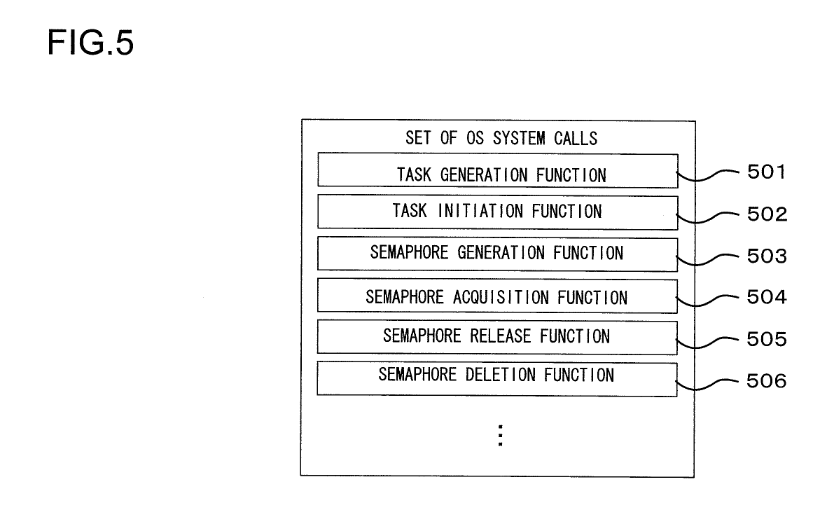

FIG. 5 shows a set of OS system calls in the present embodiment. The OS system calls are a programming function to execute the OS functions shown in FIG. 4. For example, the OS system calls to achieve the task generation and initiation function 401 and the task priority setting function 406 include a task generation function 501, a task initiation function 502, and the like. The OS system calls to achieve the exclusive control function include a semaphore generation function 503, a semaphore acquisition function 504, a semaphore release function 505, a semaphore deletion function 506, and the like. A publicly known programming function may be used for the set of OS system calls.

The semaphore generation function 503 is a function with which each of the OSs generates a semaphore. The semaphore deletion function 506 is a function to delete the semaphore.

The semaphore acquisition function 504 is a function to be executed when the resource of each of the OSs is attempted to be acquired so that each of the OSs performs processing of the task. Each of the OSs obtains a semaphore counter value corresponding to the resource, if the semaphore counter value is 0, stores the task in the semaphore queue, and, if the semaphore counter value is 1 or greater, continues the processing of the task and decrements the value of the semaphore counter by 1.

The semaphore release function 505 is a function to release the resource which each of the OSs has acquired for processing the task. Each of the OSs makes a decision as to whether or not the number of the tasks in the semaphore queue is 1 or greater and, if the number of the tasks in the semaphore queue is 1 or greater, restarts the execution of the task stored in the semaphore queue, whilst, if it is 0, increments the value of the semaphore counter by 1.

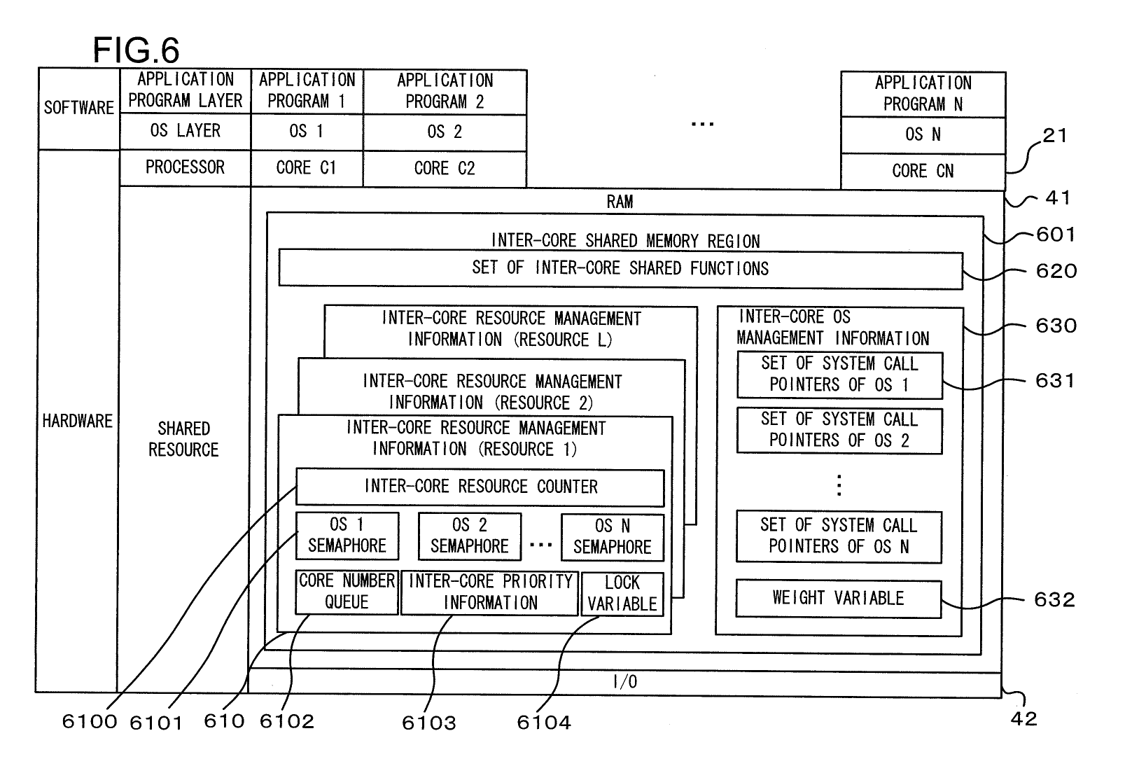

FIG. 6 shows the scheme of the exclusive control method in the present embodiment. In the present embodiment, the RAM 41 includes therein a memory area to which a plurality of cores can access. The memory area will be referred to as an inter-core shared memory region 601. In the inter-core shared memory region 601, inter-core resource management information 610 corresponding to each inter-core shared resource, a set of inter-core shared functions 620, and inter-core OS management information 630 are stored.

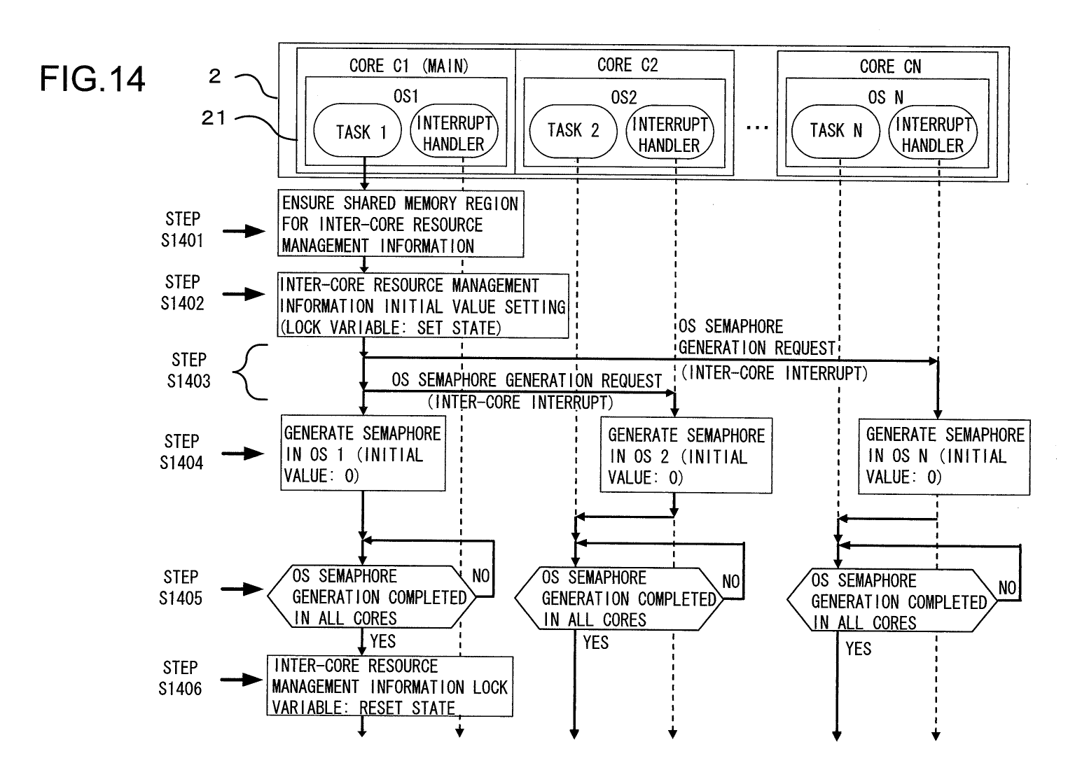

The inter-core resource management information 610 is management information for exclusive control in relation to acquisition of an inter-core shared resource between the plurality of cores 21. The inter-core resource management information 610 is created by the cores 21 for each inter-core shared resource existing in the computer system 1 and stored in the inter-core shared memory region 601. The processing in which the cores 21 create the inter-core resource management information 610 and store it in the inter-core shared memory region 601 will be described later with reference to FIG. 14.

The inter-core resource management information 610 is composed of an inter-core resource counter 6100, a semaphore 6101 of each of the OSs, a core number queue 6102, inter-core priority information 6103, and a lock variable 6104.

The inter-core resource counter 6100 stores the remaining number of inter-core shared resources. When attempting to acquire the inter-core shared resources, the cores 21 continue processing of the task if the value of the inter-core resource counter 6100 is 1 or greater and request the OS semaphore 6101 to turn the task into the waiting state if the value of the inter-core resource counter 6100 is 0.

The semaphore 6101 of each of the OSs is a semaphore generated by the semaphore generation function 503 in each of the OSs. The semaphore 6101 of each of the OSs manages the task to be processed in each of the cores. While in FIG. 6, the semaphore 6101 of each of the OSs is included in the inter-core resource management information 610 to ménage the inter-core shared resources, the inter-core resource management information 610 and the semaphore 6101 of each of the OSs may be independent. In this case, it is necessary for a pointer or ID for the semaphore 6101 of each of the OSs to be included in the inter-core resource management information 610 so that the inter-core resource management information 610 can manage the semaphore 6101 of each of the OSs.

The core number queue 6102 is a queue in which the core numbers of the cores 21 for processing a task for which resource acquisition was requested but has been failed are stored. The computer system 1 manages a task in the waiting state using the queue of the semaphore 6101 of each of the OSs and the core number queue 6102.

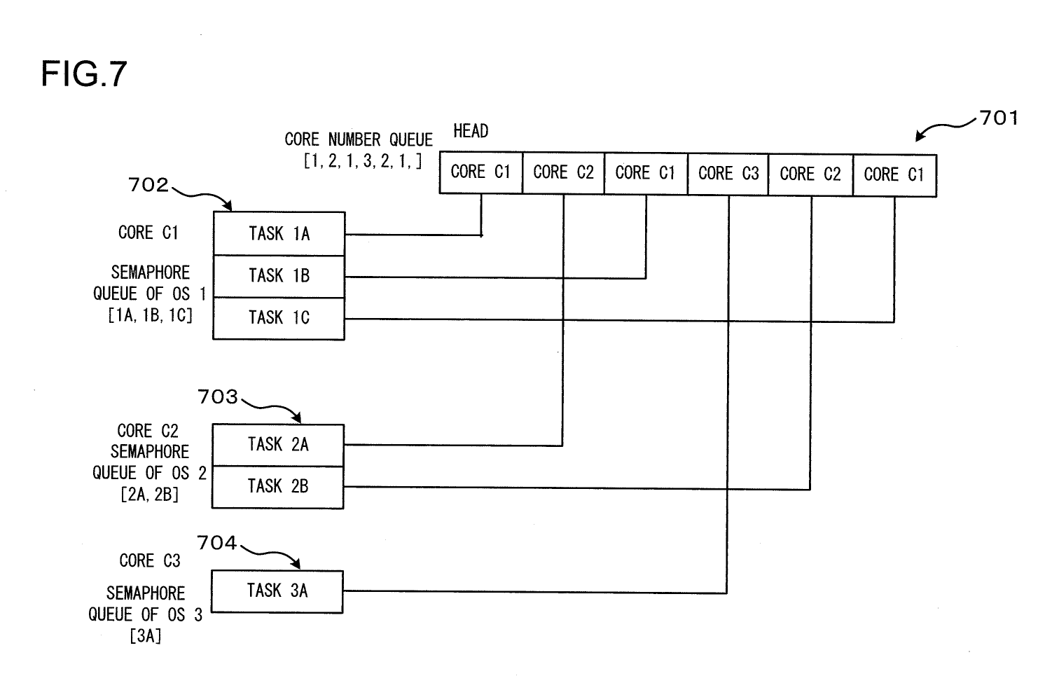

The relationship between the core number queue 6102 and the queue of the semaphore 6101 of each of the OSs is illustrated in FIG. 7. In FIG. 7, a reference numeral 701 denotes the order of cores represented by the core number queue 6102 of FIG. 6 which is, for example, [1, 2, 1, 3, 2, 1]. In addition, a reference numeral 702 denotes the order of tasks represented by the semaphore queue of an OS 1 which is, for instance, [1A, 1B, 1C]. Similarly, reference numerals 703 and 704 denote the orders of tasks represented by the semaphore queue of an OS 2 and the semaphore queue of an OS 3 which are, for example, [2A, 2B] and [3A], respectively. The head of the core order 701 is “core C1”. On the other hand, the head of the task order 702, which represents the semaphore queue of the OS 1 operating on the core C1, is “task 1A”. In other words, the “core C1” in the head of the core order 701 corresponds to the “task 1A” in the head of the task order 702. Similarly, each of the cores at another position of the core order 701 corresponds to each of the task orders 702 to 704 as illustrated in FIG. 7.

In the present embodiment, upon release of a resource, as for a core (the “core C1” in the example of FIG. 7) corresponding to the core number stored in the head of the core number queue 6102, a task (the “task 1A” in the example of FIG. 7) in the head of the semaphore queue of the OS running on the core is caused to acquire the resource.

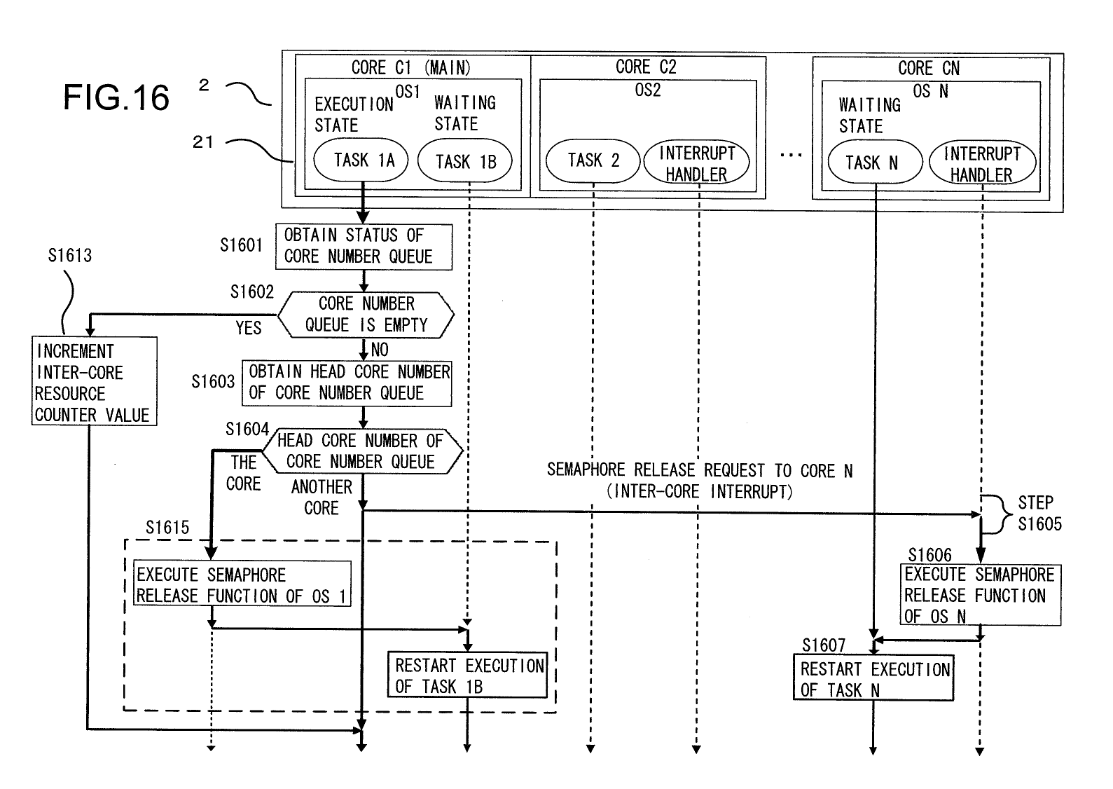

When the inter-core shared resource is released, the core number to acquire the inter-core shared resource is obtained from the core number queue 6102. Then, the task on the core of the obtained core number acquires the inter-core shared resource. Its procedure will be described later in FIG. 16.

The inter-core priority information 6103 is information for setting the priority order for each of the cores and controlling the waiting order for the core number queue 6102.

The lock variable 6104 is a variable to exclusively control the inter-core resource management information 610 itself between the plurality of cores 21. The lock variable 6104 has two states, which are a set state and a reset state. When a core in the cores 21 sets the lock variable 6104 in the set state, any access other than the lock variable 6104 is limited from another core to the inter-core resource management information 610 until the core sets the lock variable in the reset state.

The set of inter-core shared functions 620 is a set of functions used to execute processing such as exclusive control in relation to the inter-core shared resources. The set of inter-core shared functions 620 includes functions that use the inter-core resource management information 610 and the inter-core OS management information 630 so as to execute processing such as the exclusive control. It is to be noted that the set of inter-core shared functions 620 may be stored not the RAM 41 but in a ROM or the like in advance.

The inter-core OS management information 630 stores a set of system call pointers 631 of each of the OSs so as to execute OS system calls in a function included in the set of inter-core shared functions 620. It is to be noted that the inter-core OS management information 630 further includes a weight variable 632 so as to perform registration queuing of the plurality of cores in registration of the OS system calls.

The weight variable 632 can store information as to whether or not each of the cores has registered OS system calls of each of the OSs in the inter-core shared memory region 601. When the multi-core processor 2 includes N cores for example, the weight variable 632 may be an N-bit binary number where one bit is assigned to each of the cores.

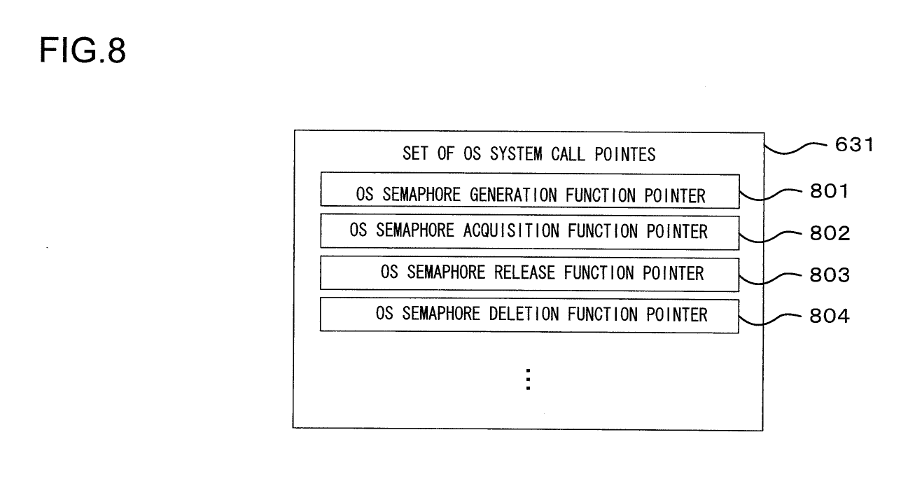

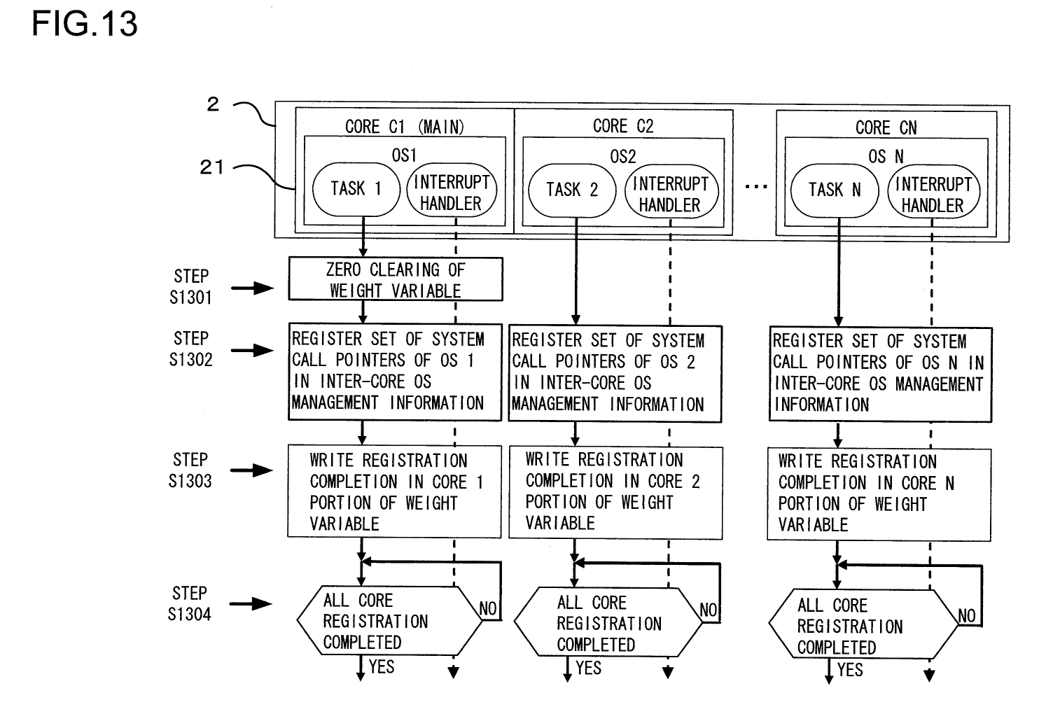

FIG. 8 shows the set of system call pointers 631 of each of the OSs in the present embodiment. The OS system calls shown in FIG. 5 are stored in the inter-core shared memory region 601 on the RAM 41 by the processing according to FIG. 13, which will be described later.

The set of system call pointers 631 of each of the OSs includes addresses on the inter-core shared memory region 601 in which the OS system calls shown in FIG. 5 are stored. An OS semaphore generation function pointer 801 is an address on which the semaphore generation function 503 of FIG. 5 is stored in the inter-core shared memory region 601. An OS semaphore acquisition function pointer 802 is an address on which the semaphore acquisition function 504 of FIG. 5 is stored in the inter-core shared memory region 601. An OS semaphore release function pointer 803 is an address on which the semaphore release function 505 of FIG. 5 is stored in the inter-core shared memory region 601. An OS semaphore generation function pointer 804 is an address on which the semaphore generation function 506 of FIG. 5 is stored in the inter-core shared memory region 601.

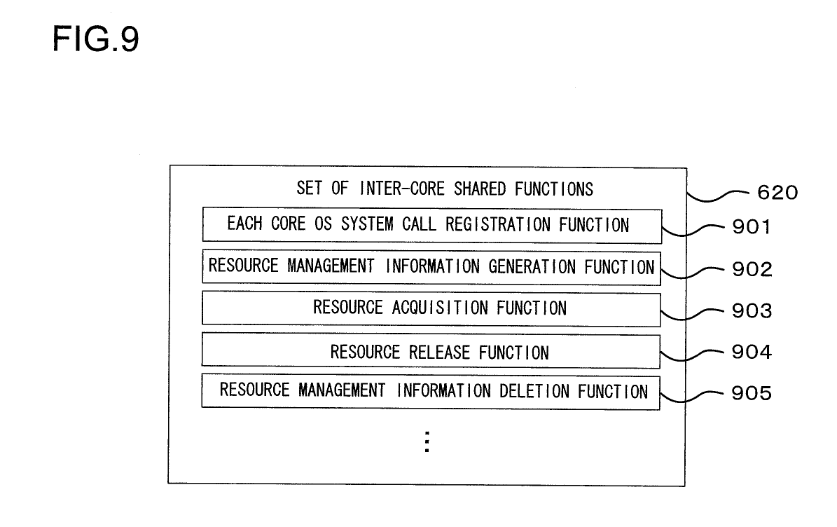

FIG. 9 shows the set of inter-core shared functions 620 in the present embodiment. The set of inter-core shared functions 620 includes an each core OS system call registration function 901, a resource management information generation function 902, a resource acquisition function 903, a resource release function 904, and a resource management information deletion function 905.

The each core OS system call registration function 901 is a program function to register the set of system call pointers 631 provided by the OS on each of the cores in the inter-core OS management information 630. The processing of the each core OS system call registration function 901 will be described later in detail with reference to FIG. 13.

The resource management information generation function 902 is a program function to generate the inter-core resource management information 610 in the inter-core shared memory region 601. The processing of the resource management information generation function 902 will be described later in detail with reference to FIG. 14.

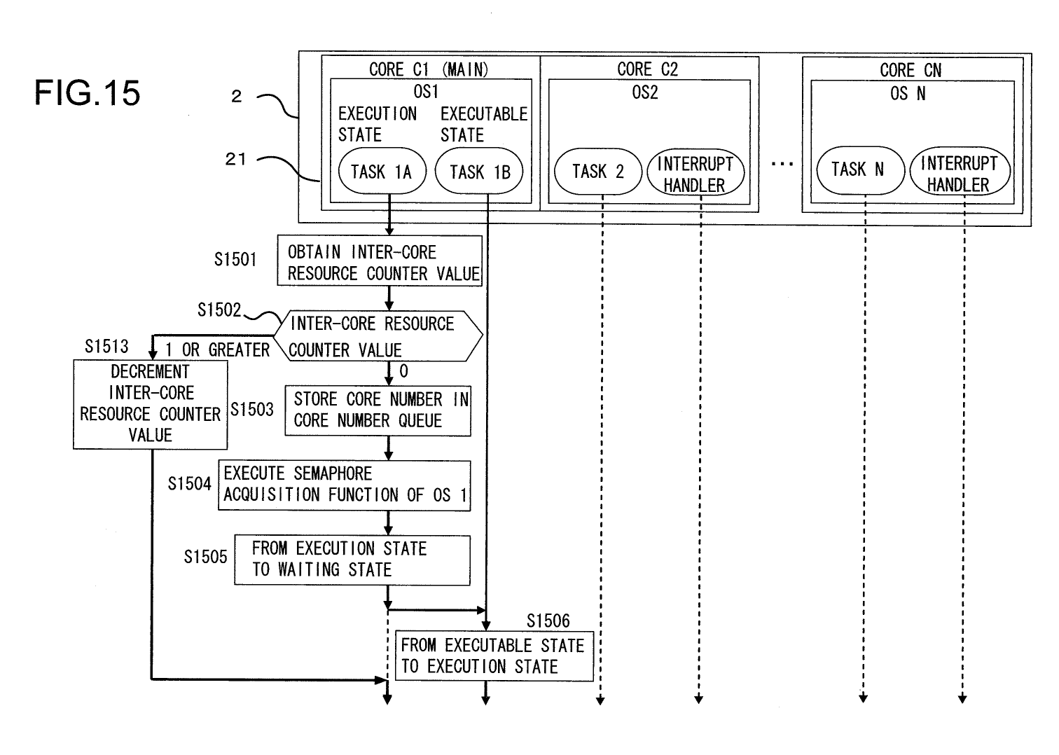

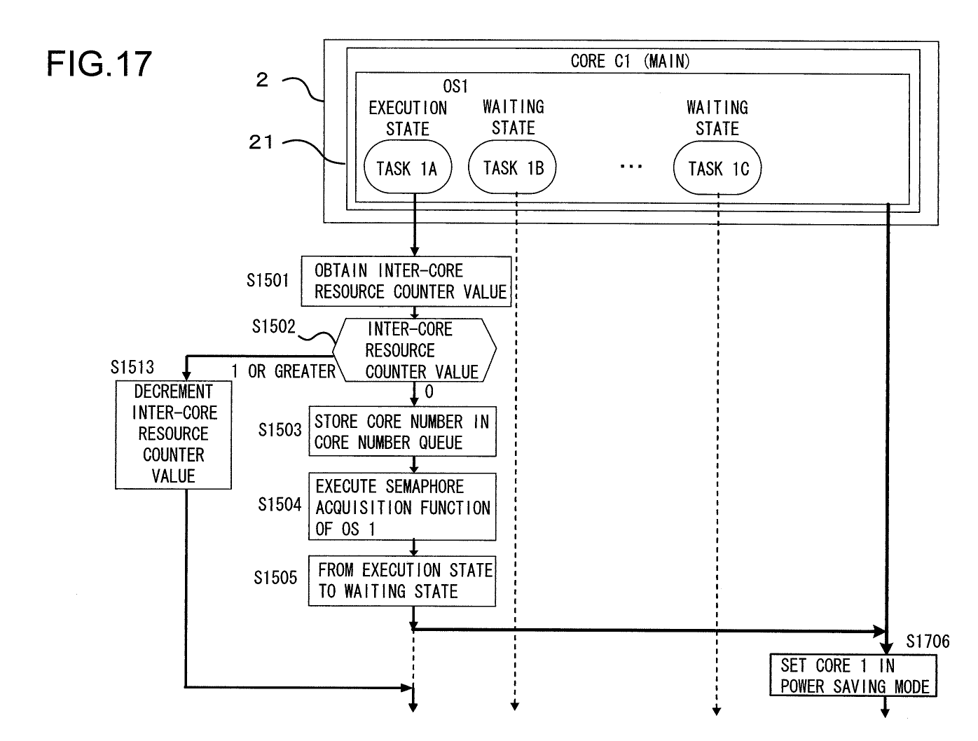

The resource acquisition function 903 is a program function to allow the task to acquire the inter-core shared resource with reference to the inter-core resource management information 610. The resource acquisition function 903 will be described later in detail with reference to FIG. 15 and FIG. 17.

The resource release function 904 is a program function to allow the task to release the inter-core shared resource with reference to the inter-core resource management information 610. The resource release function 904 will be described later in detail with reference to FIG. 16.

The resource management information deletion function 905 is a program function to delete the inter-core resource management information 610 from the inter-core shared memory region 601.

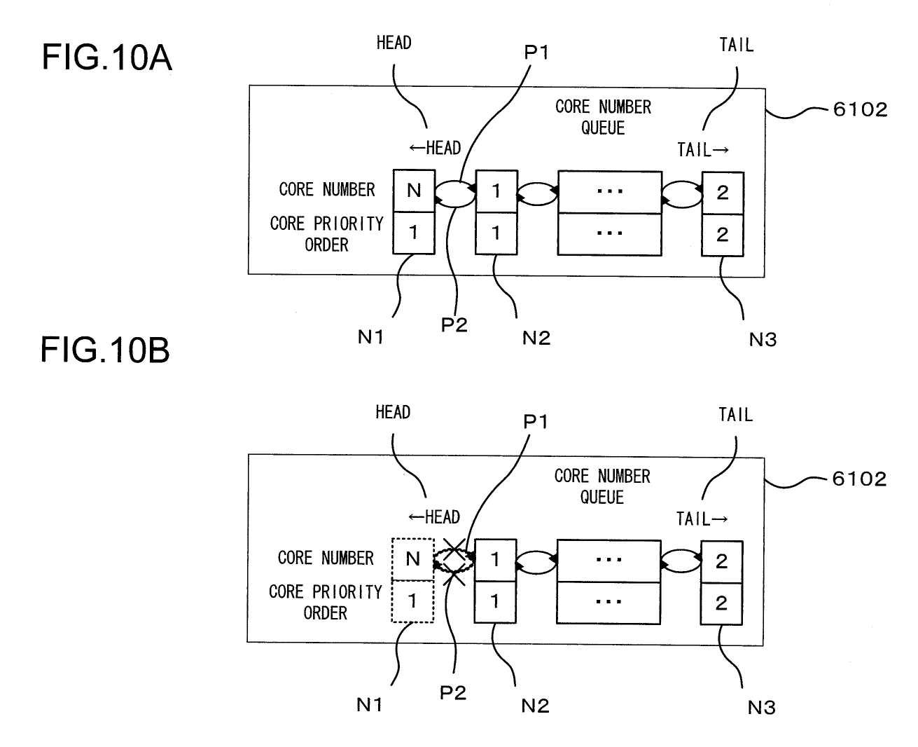

FIG. 10A shows the core number queue 6102 in the present embodiment. The core number queue 6102 assumes a linked list structure with the core numbers queuing for a resource acquisition request as nodes whose context is indicated by a pointer. In addition, the core number queue 6102 may include pointers HEAD and TAIL, which indicate its head and tail, respectively. The pointers HEAD and TAIL may be NULL when the core number queue 6102 is blank. Since in the core number queue 6102, the core numbers can be rearranged according to the priority order, information relating to the priority order of the core numbers may be stored together with the core number. The priority order of each of the core numbers indicates which core preferentially acquires an inter-core shared resource. The information relating to the priority order of the core number is determined based upon the inter-core priority information 6103.

When the resource release function 904 of FIG. 9 releases an inter-core shared resource, the core number of the head in the core number queue 6102 is obtained as the core number of which the released inter-core shared resource is to be acquired next. FIG. 10B shows a state after the core number of the head is obtained in the core number queue 6102 shown in FIG. 10A. In FIG. 10B, the value of the obtained core number is deleted from the core number queue 6102. For instance, pointers P1 and P2, connected to the nodes of the core numbers, are separated and a node N1 of the core number is deleted. Then, a node N2 of the core number, which is connected to the node N1 of the deleted core number, is assigned to be the head of the queue.

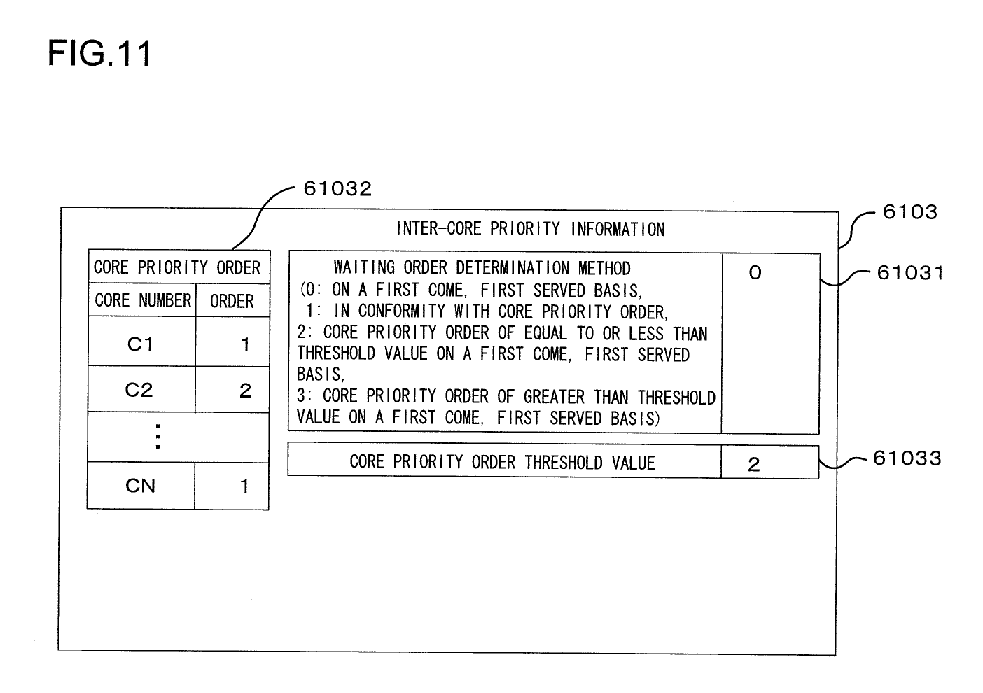

FIG. 11 shows an example of the inter-core priority information 6103 in the present embodiment. The inter-core priority information 6103 includes a value 61031 showing waiting order determination method, a priority order 61032 of each core number, and a core priority order threshold value 61033. Using those pieces of the inter-core priority information 6103, the core number queue 6102 can be rearranged in order of priority.

The value 61031 showing waiting order determination method is used to make a decision on a method to arrange the core numbers in the core number queue 6102. The waiting order determination methods include those on a first come, first served basis, those on a priority basis, and those on the basis of a hybrid of a first come, first served basis and a priority basis such as those “on a first come, first served basis if the priority order of the core number is the core priority order threshold value 61033 or less and on a priority basis if not” and “on a first come, first served basis if the priority order of the core number is greater than the core priority order threshold value 61033 and on a priority basis if not”. When the waiting order determination method of a hybrid of a first come, first served basis and a priority basis is used, the core priority order threshold value 61033 indicates a threshold value of the priority order of the core number showing a boundary between the use of a first come, first served basis and that of a priority basis.

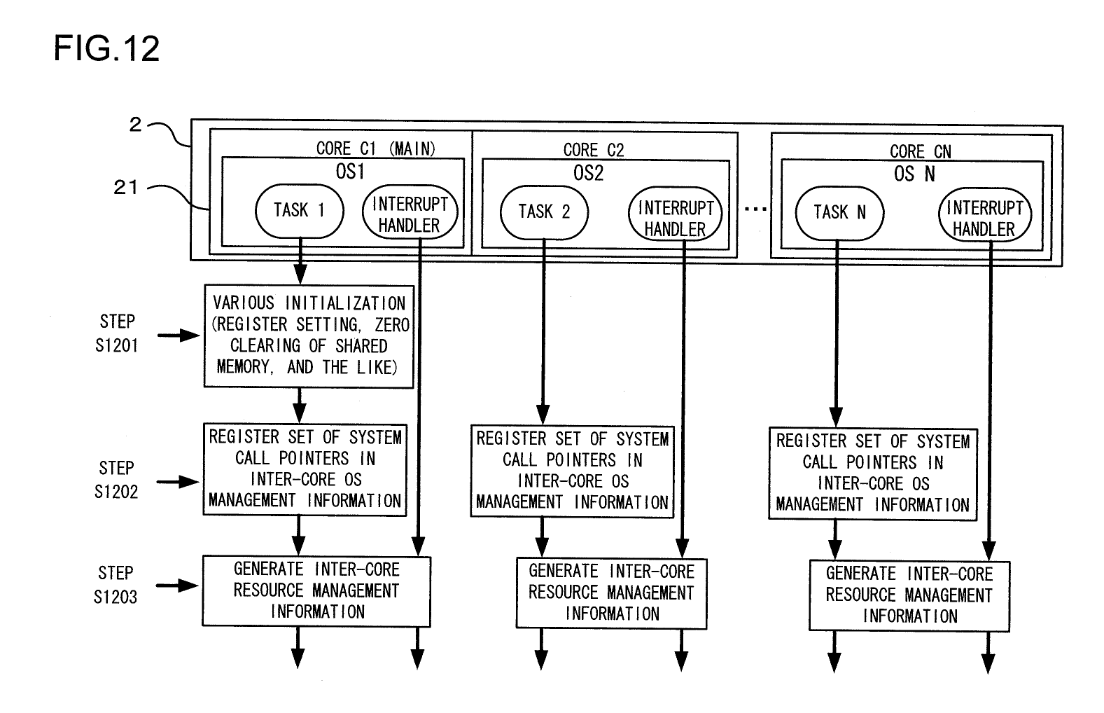

FIG. 12 is an example of the process flow of an initialization procedure required to generate the inter-core resource management information 610 in the present embodiment. In FIG. 12, the multi-core processor 2 sets a main core 21 in advance and determines tasks to be initialized on the OS running on each of the cores. As an example, in FIG. 12, the core C1 works as the main core. The core C1, a core C2, and a core CN generate and initiate a task 1, a task 2, and a task N, respectively, which are to execute processing of FIG. 12.

In a step S1201 of FIG. 12, the main core C1 performs a variety of initializations by the task 1. The variety of initializations include register setting required for hardware initialization such as clearing and masking of a hardware interrupt and zero clearing of the inter-core shared memory region 601.

In a next step S1202, those tasks performing initialization such as the task 1, the task 2, and the task N execute the each core OS system call registration function 901 and register the set of system call pointers 631 of each of the OSs to the inter-core OS management information 630 so that inter-core shared functions such as the resource release function 904 stored in the set of inter-core shared functions 620 can use OS system calls. The processing in the step S1202 will be described later in detail with reference to FIG. 13.

In a last step S1203, the task 1 of the core C1, which performs the initialization, and the interrupt handler of each of the cores other than the core C1 execute the resource management information generation function 902 so as to generate the inter-core resource management information 610. The processing in the step S1203 will be described later in detail with reference to FIG. 14. Upon completion of the generation of the inter-core resource management information 610, the processing of FIG. 12 is finished.

FIG. 13 shows an example of the process flow of the each core OS system call registration function 901 in the present embodiment. The process flow shown in FIG. 13 is executed in the step S1202 of FIG. 12 and the like. Prior to the execution of the each core OS system call registration function 901, a main core is to be set in advance among the cores 21 in the multi-core processor 2. In FIG. 13, with the core C1 working as a main core, the core C1, the core C2, and the core CN generate and initiate the task 1, the task 2, and the task N respectively as tasks for registration of OS system calls.

In a step S1301 of FIG. 13, the task 1 performs zero clearing for the weight variable 632 of the inter-core OS management information 630.

In a next step S1302, the tasks 1 to N store OS system calls of each of the OSs in the inter-core shared memory region 601 and register an address in which each of the OS system calls is stored in the inter-core OS management information 630 as the set of system call pointers 631.

In a step S1303, then, each of the task 1, the task 2, and the task N, where the registration of the set of system call pointers has been completed in the step S1302, writes a value which indicates complete of OS system call registration, e.g. 1, in a bit corresponding to each of the cores of the weight variable 632.

After that, in a step S1304, the task 1, the task 2, and the task N check as to whether or not all the bits of the weight variable 632 have been written and wait in a loop for all the bits to be written. After all the bits have been written, the loop is terminated and the processing of FIG. 13 is finished.

FIG. 14 shows an example of the flow of the resource management information generation function 902 in the present embodiment. Prior to the execution of the resource management information generation function 902, a main core is to be set in advance among the cores 21 in the multi-core processor 2. In FIG. 14, with the core C1 working as a main core, the core C1, the core C2, and the core CN set the task 1, the task 2, and the task N, respectively, in relation to the tasks to execute the resource management information generation function 902.

In a step S1401 of FIG. 14, the task 1 ensures in the inter-core shared memory region 601 a memory area in which the inter-core resource management information 610 is generated.

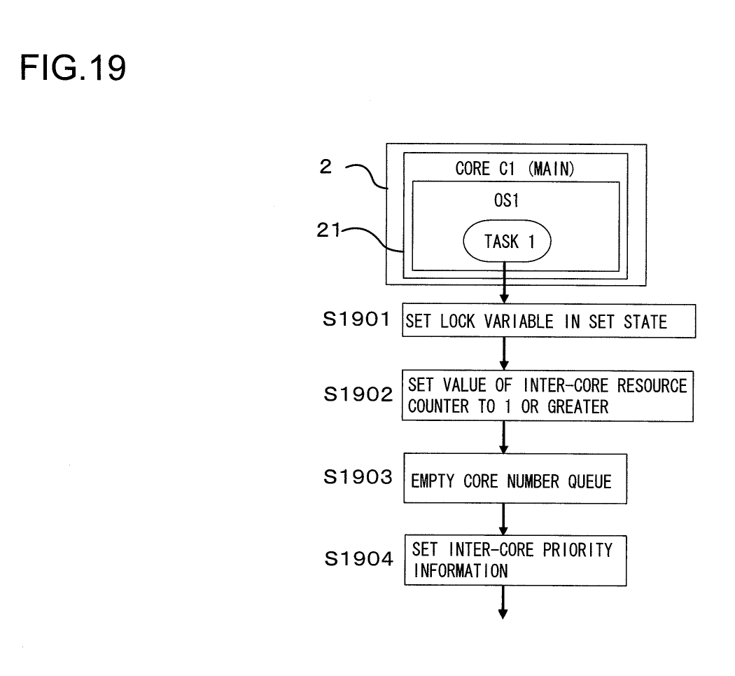

In a next step S1402, initial value setting for the inter-core resource management information 610 is performed. The initial value setting for the inter-core resource management information 610 will be described later in detail with reference to FIG. 19. When the initial value setting of the inter-core resource management information 610 is performed, the lock variable 6104 is to be set in the set state. This prohibits tasks or cores other than the task 1, which has performed the initial value setting for the inter-core resource management information 610, from accessing those other than the lock variable 6104 of the inter-core resource management information 610.

In a next step S1403, the task 1 uses an inter-core interrupt to transmit an OS semaphore generation request to the interrupt handlers of the OS 2 and the OS N.

In a next step S1404, the task 1 and the interrupt handlers of the OS 2 to the OS N generate the OS semaphore 6101 in the inter-core shared memory 601. It is to be noted that, as mentioned earlier, the lock variable 6104 does not limit the access in relation to the OS semaphores. At this time, the counter value of the OS semaphore 6101 is set to 0.

The interrupt handlers of the OS 2 and the OS N, having generated the OS semaphore 6101, finish the processing. At this time, the OS 2 and the OS N transfer control to the task 2 to the task N.

In a step S1405, then, the task 1, the task 2, and the task N check as to whether or not the OS semaphore 6101 has been generated in all the cores. If the OS semaphore 6101 has not been generated in any of the cores, the tasks wait in a loop for the OS semaphore 6101 to be created in all the cores. After the OS semaphore 6101 has been created in all the cores, the loop in the step S1405 is terminated. Then the flow of control proceeds to a step S1406, so that the task 1 sets the lock variable 6104 of the inter-core resource management information 610 in the reset state so as to finish the processing.

FIG. 15 shows an example of the flow of the resource acquisition function 903 in the present embodiment. In FIG. 15, a task 1A and a task 1B have been initiated on the OS 1, the task 1A is in the execution state and the task 1B is in the executable state, and the task 1A is to acquire an inter-core shared resource.

At first, in a step S1501 of FIG. 15, the task 1A obtains the value of the inter-core resource counter 6100. Then, in a step S1502, if the value of the inter-core resource counter 6100 obtained in the step S1501 is 1 or greater, i.e., if there is an inter-core shared resource left, the flow of control transitions to a step S1513, so that the task 1A decrements the value of the inter-core resource counter 6100 and acquires an inter-core shared resource. If in the step S1502 the value of the inter-core resource counter 6100 is 0, a decision is made that an inter-core shared resource is insufficient, the flow of control transitions to a step S1503, so that the task 1A stores the core number in the core number queue 6102.

After the core number has been stored in the core number queue 6102 in the step S1503, the flow of control transitions to a step S1504, so that the task 1A requests the OS 1 for resource acquisition queue processing by executing the semaphore acquisition function 504 with reference to the OS semaphore acquisition function pointer 802 of the OS 1.

In a step S1505, the task 1A transfers from the execution state to the waiting state so as to acquire the OS semaphore 6101 with zero remaining. Then, the OS 1 transitions to a step S1506.

In the step S1506, the OS 1 sets the task 1B from the executable state to the execution state.

FIG. 16 shows an example of the resource release function 904 in the present embodiment. Prior to execution of the resource release function 904, a main core is to be set in advance among the cores 21 in the multi-core processor 2. In FIG. 16, with the core C1 working as a main core, the task 1A and the task 1B are generated and initiated on the OS 1 of the core C1 and the task N is generated and initiated on the OS N of the core CN as tasks for executing the resource release function 904. The task 1A is in the execution state, has already acquired an inter-core shared resource, and is to release the inter-core shared resource. In addition, the task 1B and the task N have not acquired an inter-core shared resource and are therefore in the waiting state. For this reason, the core number of the core C1, which performs processing of the task 1B, and the core number of the core CN, which performs processing of the task N, are stored in the core number queue 6102.

In a step S1601 of FIG. 16, the task 1A obtains a state of the core number queue 6102. Then, the flow of control transitions to a step S1602, so that, based upon the state of the obtained core number queue 6102, a decision is made as to whether or not the core number queue 6102 is empty. The state of the core number queue 6102 may refer to, for instance, a pointer HEAD indicating the head of the core number queue 6102 or the like, and in the step S1602 a decision may be made as to whether or not the reference of the pointer HEAD is NULL.

If in the step S1602 the decision is made that the core number queue 6102 is empty, the flow of control transitions to a step S1613, and if the decision is made that the core number queue 6102 is not empty, the flow of control transitions to a step S1603.

In the step S1613, an inter-core shared resource is released, the inter-core resource counter 6100 value corresponding to the inter-core shared resource is incremented, and the processing of FIG. 16 is finished.

In the step S1603, the core number in the head of the core number queue 6102 is obtained. The core number in the head may be obtained, for example, with reference to the pointer HEAD. If the core number in the head of the core number queue 6102 is of the core C1, the core number “C1” is obtained. In addition, if similarly the core number in the head of the core number queue 6102 is of the core CN, the core number “CN” is obtained.

In a step S1604, the flow of control transitions to a step S1615 if the core number in the head of the queue 6102 obtained in the step S1603 is of the core (the core C1, in this example). On the other hand, the flow of control transitions to a step S1605 if the core number in the head of the queue 6102 is of another core (the core CN, in this example).

In the step S1615, the task 1A executes the semaphore release function 505 of the OS 1. As a result, the task 1A releases the acquired inter-core shared resource. Then, the OS 1 of the core C1 restarts the execution by transitioning the task 1B stored in the semaphore queue of the OS 1 from the waiting state to the execution state.

In the step S1605, the task 1A uses an inter-core interrupt to transmit a semaphore release request of the OS N to the interrupt handler of the OS N, and then the task 1A finishes the processing of FIG. 16.

In a step S1606, the interrupt handler of the OS N executes the semaphore release function 505 of the OS N. At this time, the semaphore counter of the semaphore of the OS N is 0, and thus the semaphore counter is incremented by the processing of the semaphore release function 505. Then, the flow of control transitions to a step S1607, so that the semaphore counter became 1, and thus the OS N acquires an inter-core shared resource and causes the task N to transition from the waiting state to the execution state. This causes the task N to restart the execution.

FIG. 17 is a process flow showing an operation when there is no other task in the executable state upon execution of the resource acquisition function 903 in the present embodiment. In the present process flow, the task 1A, the task 1B, and a task 1C have been initiated on the OS 1, and the task 1A is in the execution state, and the task 1B and the task 1C are in the waiting state. The task 1A executes the resource acquisition function 903 so as to acquire an inter-core shared resource.

The task 1A proceeds the processing in the similar manner to FIG. 15 up to the step S1505. In the step S1505, when the task 1A transfers from the execution state to the waiting state, there is no other task in the executable state on the core C1, and thus the OS 1 uses the power saving function 405 to set the core C1 in power saving mode and completes the processing of FIG. 17.

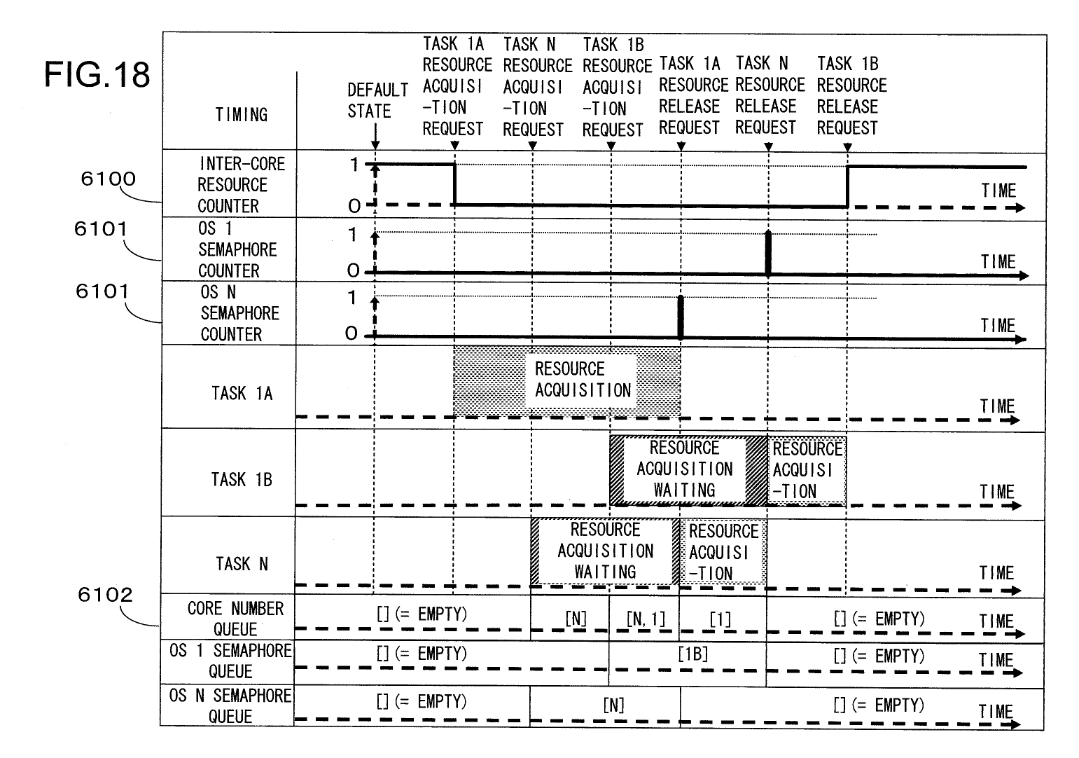

FIG. 18 shows a time chart in relation to the inter-core resource management information 610 and transition of the state of the plurality of tasks. In the present time chart, at least the OS 1 is running on the core C1 and the OS N is running on the core CN, and the task 1A and the task 1B are running on the OS 1 and the task N is running on the OS N. In addition, a state in which the inter-core resource counter 6100 is 1 and no tasks have acquired an inter-core shared resource is designated as the initial state. In addition, as described earlier, the semaphore counter of the semaphore of each of the OSs is 0 in the initial state. In addition, as described earlier, the OS 1 semaphore is composed of an OS 1 semaphore counter and an OS 1 semaphore queue. Similarly, the OS 2 semaphore is composed of an OS 2 semaphore counter and an OS 2 semaphore queue, and the OS N semaphore is composed of an OS N semaphore counter and an OS N semaphore queue. Then, the semaphore counter of the semaphore of each of the OSs is 0 in the initial state.

In FIG. 18, the resource acquisition function 903 is executed in order of the task 1A, the task N, and the task 1B so as to request acquisition of the inter-core shared resource. Then, the resource release function 904 is executed in order of the task 1A, the task N, and the task 1B so as to request release of the inter-core shared resource.

In the initial state of FIG. 18, the value of the inter-core resource counter 6100 is 1, the semaphore counter of the OS 1 is in an acquisition state, the OS N semaphore counter is in the acquisition state, and the queue is empty.

At first, when the task 1A is set in the execution state and requests acquisition of the inter-core shared resource, the value of the inter-core resource counter 6100 is 1 (determined to be “1 or greater” in the step S1502 of FIG. 15). Therefore the task 1A acquires the inter-core shared resource and decrements the value of the inter-core resource counter 6100 to 0 (the step S1513 of FIG. 15).

Next, when the task N is set in the execution state and requests acquisition of the inter-core shared resource, the value of the inter-core resource counter 6100 is 0 (determined to be “0” in the step S1502 of FIG. 15). Therefore the task N fails to acquire the inter-core shared resource, transitions to the waiting state to wait for resource acquisition, and is stored in the core number queue 6102 (the steps S1503 to S1505 of FIG. 15). At this time, the core number queue 6102 becomes [N]. In addition, the task N joins the semaphore queue of the OS N, thereby becoming [N].

Next, when the task 1B is set in the execution state and requests acquisition of the inter-core shared resource, the value of the inter-core resource counter 6100 is 0. Therefore, similarly to the task N, the task 1B transitions to the waiting state to wait for resource acquisition, and the core number queue 6102 becomes [N, 1]. In addition, the task 1B joins the OS 1 semaphore queue, thereby becoming [1B].

Next, when the task 1A in the execution state requests release of the inter-core shared resource, the task 1A releases the inter-core shared resource. Then, since the core number queue 6102 is not empty (determined to be NO in the step S1602 of FIG. 16) and the core number in the head of the core number queue 6102 is the core CN, which is another core (determined to be “another core” in the step S1604 of FIG. 16), a release request of the semaphore of the OS N is made to the core CN (the step S1605 of FIG. 16). Then, the semaphore release function 505 of the OS N is executed by the interrupt handler of the OS N, the OS N semaphore counter is incremented to 1 (the step S1606 of FIG. 16), and the OS N causes the task N to acquire the inter-core shared resource so as to decrement the semaphore of the OS N, thereby returning to 0. Then, the task N transitions from the waiting state for resource acquisition to the execution state (the step S1607 of FIG. 16), and the core number queue 6102 becomes [1]. In addition, the OS N semaphore queue becomes empty.

Next, when the task N in the execution state requests release of the inter-core shared resource, the task N releases the inter-core shared resource. Then, since the core number queue 6102 is not empty (determined to be NO in the step S1602 of FIG. 16) and the core number in the head of the core number queue 6102 is the core C1, which is another core (determined to be “another core” in the step S1604 of FIG. 16), the semaphore counter of the OS 1 is incremented to 1 (the step S1606 of FIG. 16), and the OS 1 causes the task 1B to acquire the inter-core shared resource so as to decrement the semaphore of the OS 1, thereby returning to 0. The task 1B transitions from the waiting state to wait for resource acquisition to the execution state (the step S1607 of FIG. 16), and the core number queue 6102 becomes empty. In addition, the OS 1 semaphore queue becomes empty.

Next, when the task 1B in the execution state requests release of the inter-core shared resource, the task 1B releases the inter-core shared resource. Then, since the core number queue 6102 is empty (determined to be YES in the step S1602 of FIG. 16), the value of the inter-core resource counter 6100 is incremented from 0 to 1 (the step S1613 of FIG. 16).

FIG. 19 shows the process flow relating to the initial value setting of the inter-core resource management information 610 to be executed in the step S1402 of FIG. 14. The task which executes the process flow of FIG. 19 is generated and initiated by the OS 1 and designated as the task 1.

At first, in a step S1901 the task 1 sets the lock variable 6104 in the set state so as to block access from another core to the inter-core resource management information 610.

Next, the flow of control transitions to a step S1902, so that the task 1 sets the value of the inter-core resource counter 6100 to the remaining number (1 or greater) of inter-core shared resource.

Next, the flow of control transitions to a step S1903, so that the task 1 empties the core number queue 6102.

Lastly, in a step S1904 the task 1 sets the inter-core priority information 6103.

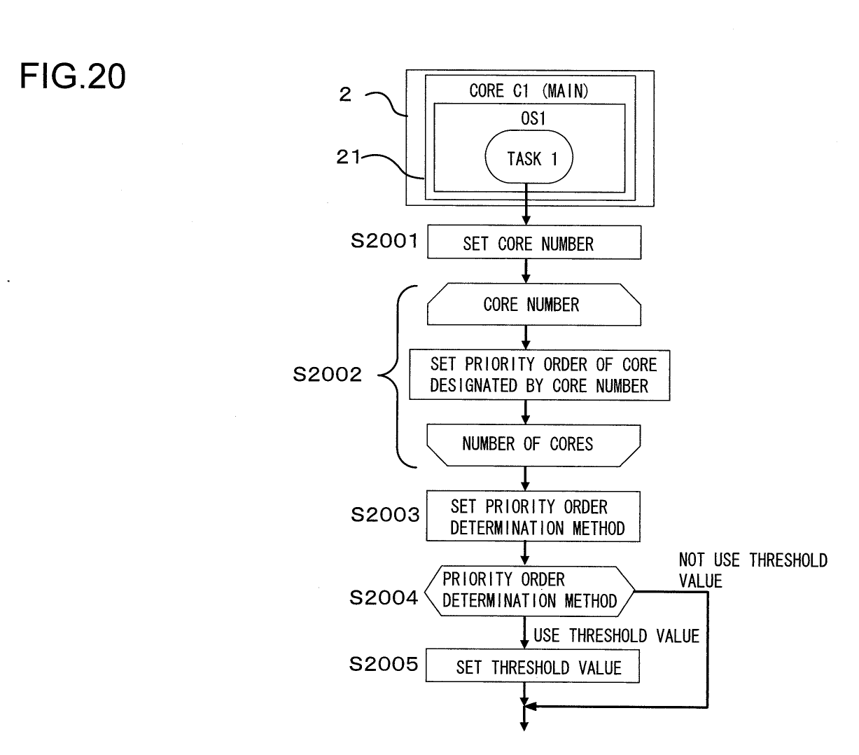

FIG. 20 shows an example of the process flow relating to setting of the inter-core priority information 6103 in the step S1904 of FIG. 19. In FIG. 20, the OS 1 generates and initiates the task 1 and sets the inter-core priority information 6103 in the format of FIG. 11.

In a step S2001 of FIG. 20, the task 1 first reads the number of cores included in the multi-core processor 2. In the present embodiment, the number of cores is predetermined and preset in the task 1.

Next, the flow of control transitions to a step S2002, so that the task 1 determines a core priority order 61032 for each core number according to the number of cores having been read in the step S2001 and stores it in the inter-core priority information 6103 of the inter-core resource management information 610. In the present embodiment, the core priority order 61032 of each core is preset by the OS 1. It is to be noted that the set value of the core priority order 61032 may vary from one inter-core shared resource to another.

Next, the flow of control transitions to a step S2003, so that the task 1 stores a waiting order determination method 61031 in the inter-core priority information 6103 of the inter-core resource management information 610. In the present embodiment, the waiting order determination method 61031 is preset in the task 1.

Next, the flow of control transitions to a step S2004, so that the task 1 makes a decision as to whether or not the waiting order determination method 61031 stored in the inter-core priority information 6103 in the step S2403 uses the inter-core priority order threshold value 61033. For example, the inter-core priority information 6103 of FIG. 11 uses the inter-core priority information 6103 if the value of the waiting order determination method 61031 is 2 or greater. The flow of control transitions to a step S2005 if a decision is made that the inter-core priority order threshold value 61033 is used, whilst the flow of control terminates the processing of FIG. 20 if a decision is made that the inter-core priority order threshold value 61033 is not used.

In the step S2005, the inter-core priority order threshold value 61033 is stored in the inter-core priority information 6103 of the inter-core resource management information 610. In the present embodiment, the inter-core priority order threshold value 61033 is preset in the task 1.

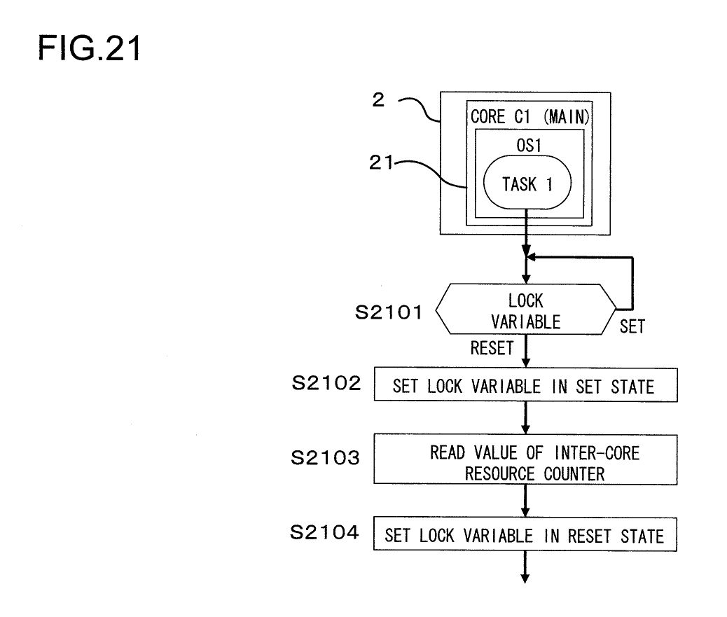

FIG. 21 shows the process flow relating to processing to obtain the value of the inter-core resource counter 6100 in the step S1501 of FIG. 15 and FIG. 17. In the explanation of FIG. 21, the task 1 having been generated and initiated by the OS 1 obtains the value of the inter-core resource counter 6100.

In FIG. 21, exclusive control is performed so as to prevent the inter-core resource counter 6100 from being changed during obtaining the inter-core resource counter 6100. Since it takes a short processing time to obtain the inter-core resource counter 6100, the lock variable 6104 is used to wait in a loop for the value of the inter-core resource counter 6100 to be obtained.

At first, in a step S2101, the task 1 obtains the state of the lock variable 6104 of the inter-core resource management information 610 and, if the lock variable 6104 is in the set state, waits in a loop for it to enter the reset state. When the lock variable 6104 enters the reset state, the flow of control proceeds to a step S2102, so that the task 1 sets the lock variable 6104 in the set state.

Next, the flow of control proceeds to a step S2103, so that the value of the inter-core resource counter 6100 is read. Upon completion of the reading, the flow of control proceeds to a step S2104, so that the lock variable 6104 is set in the reset state and the processing of FIG. 21 is finished.

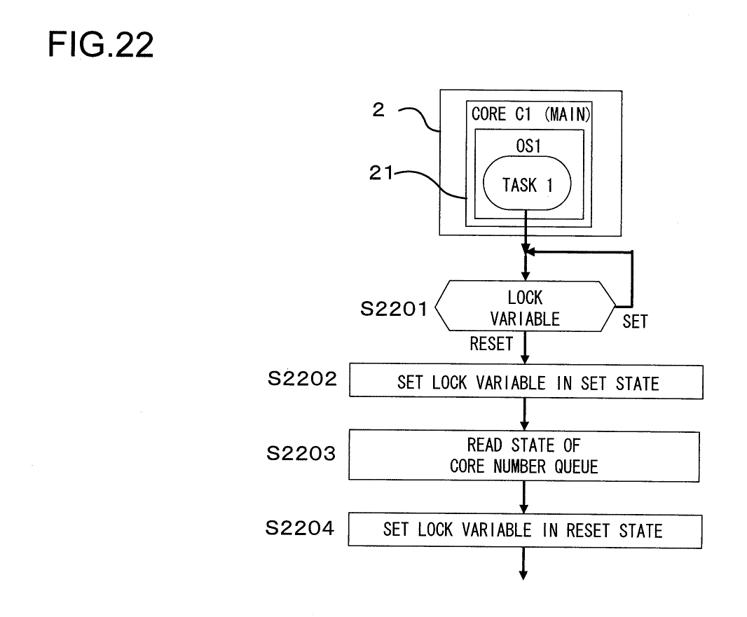

FIG. 22 shows the process flow relating to processing to obtain the state of the core number queue 6102 in the step S1601 of FIG. 16 in the present embodiment. Obtaining the state of the core number queue 6102 also uses the lock variable 6104.

At first, in a step S2201, the task 1 obtains the state of the lock variable 6104 of the inter-core resource management information 610 and, if the lock variable 6104 is in the set state, waits in a loop for it to enter the reset state. When the lock variable 6104 enters the reset state, the flow of control proceeds to a step S2202, so that the task 1 sets the lock variable 6104 in the set state.

Next, the flow of control proceeds to a step S2203, so that the state of the core number queue 6102 is read. Upon completion of the reading, the flow of control proceeds to a step S2204, so that the lock variable 6104 is set in the reset state and the processing of FIG. 22 is finished.

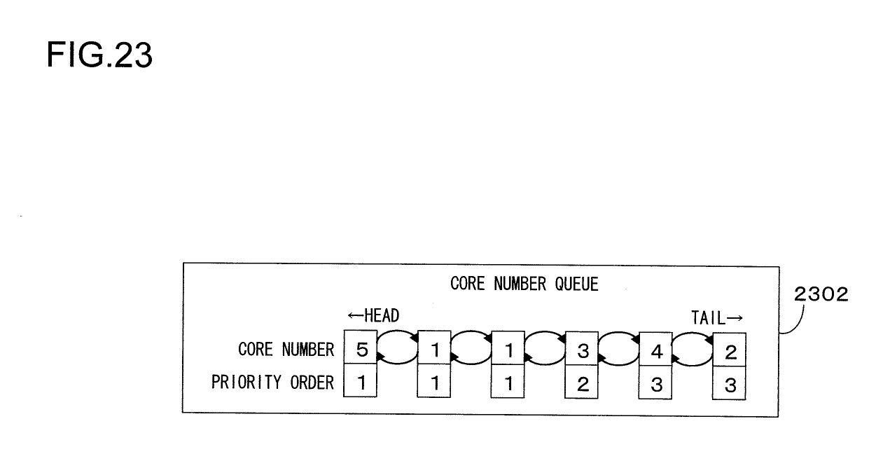

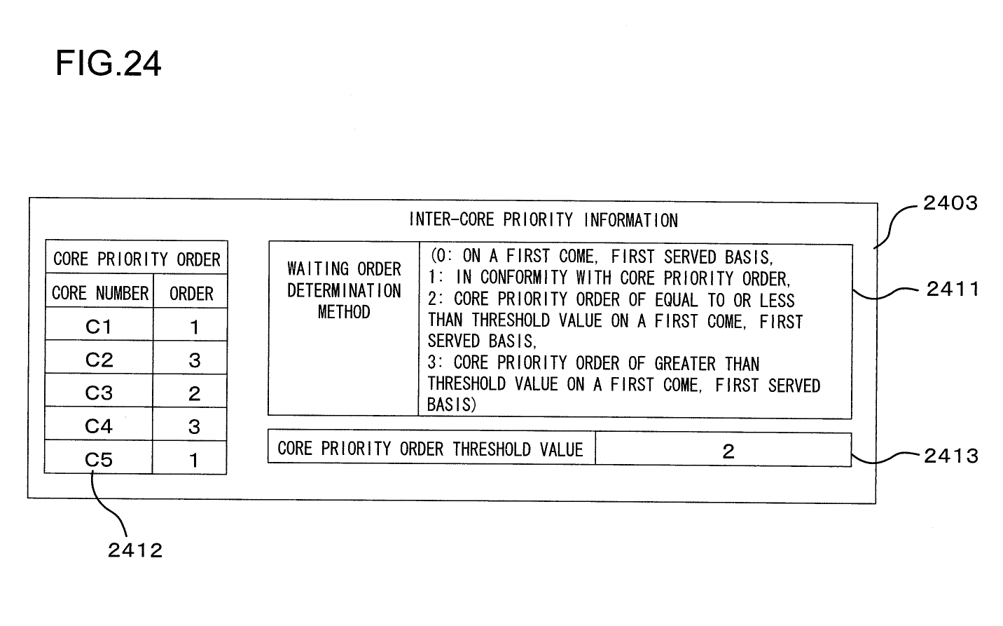

Next, a method to store a core number in the core number queue in the step S1503 of FIG. 15 and FIG. 17 will be explained with reference to examples of FIG. 23 to FIG. 28. FIG. 23 shows an example of the core number queue 6102 in the present embodiment. FIG. 24 shows an example of the inter-core priority information 6103 in the present embodiment.

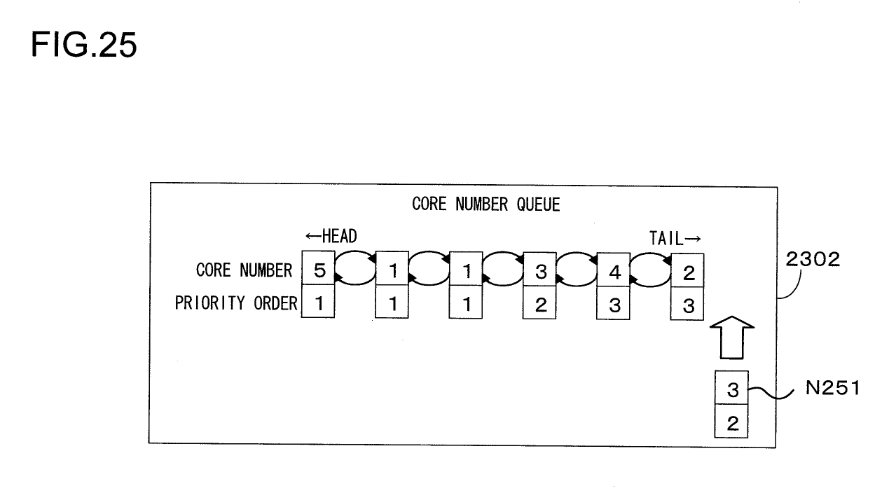

FIG. 25 shows processing to store a new node N251 of the core number “3” to a core number queue 2302 when the value of a waiting order determination method 2411 of inter-core priority information 2403 is 0 (on a first come, first served basis) in the present embodiment. When the value of the waiting order determination method 2411 of the inter-core priority information 2403 is 0 (on a first come, first served basis), the node N251 is stored in the tail of the core number queue 2302 as FIG. 25.

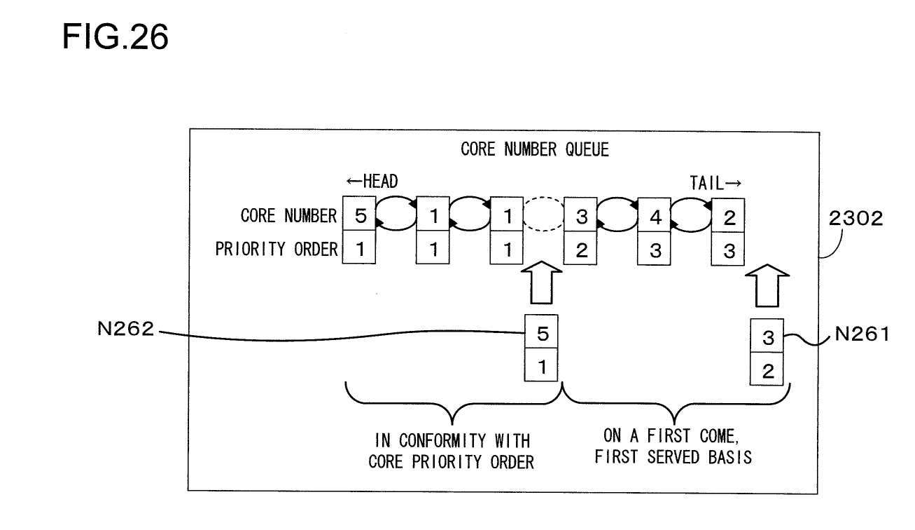

FIG. 26 shows processing to add a new core number to the core number queue 2302 when the value of the waiting order determination method 2411 is 2 (a core priority order threshold value 2413 or less is on a first come, first served basis).

When a core number whose core priority order is equal to or less than the core priority order threshold value 2413, as a node N261 of the core number “3”, is stored, a decision is made that it is on a first come, first served basis, and the node N261 is stored in the tail of the core number queue 2302.

On the other hand, when a core number whose core priority order is higher than the core priority order threshold value 2413, as a node N262 of the core number “5”, is stored, the node N262 is stored in a portion of the core number queue 2302 in which the core numbers are aligned in conformity with the core priority order.

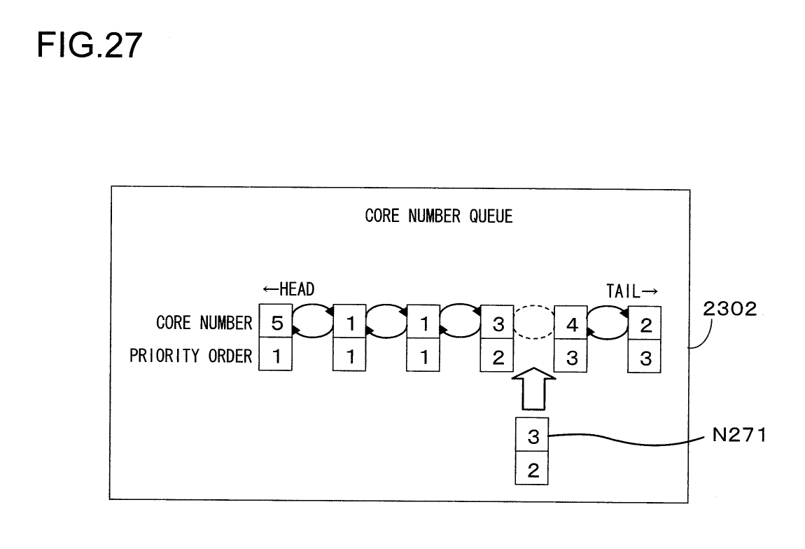

FIG. 27 shows processing to store a new node N271 of the core number “3” in the core number queue 2302 when the waiting order determination method 2411 of the inter-core priority information 2403 is 1 (in conformity with the core priority order) in the present embodiment. According to a core priority order 2412 of FIG. 24, the core priority order of core number “3” is 2. When the core number “3” with the core priority order of 2 waits for acquisition of an inter-core shared resource, the new node N271 of the core number “3” is additionally stored between a node of the core number “4” of the core priority order 3 and a node of the core number “3” of the core priority order 2 as FIG. 27.

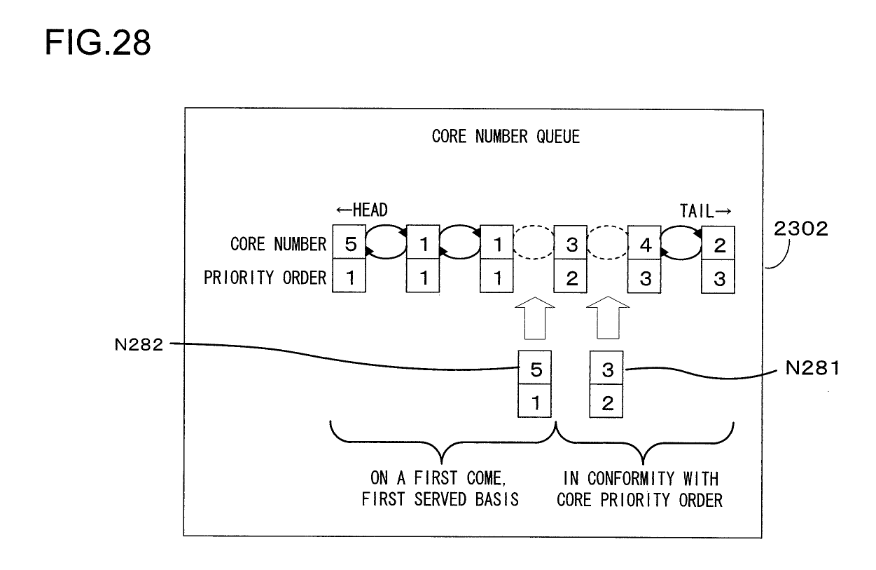

FIG. 28 shows processing to add a new core number in the core number queue 2302 when the waiting order determination method 2411 of the inter-core priority information 2403 is 3 (the core priority order of greater than the core priority order threshold value 2413 is on a first come, first served basis) in the present embodiment.

When a core number whose core priority order is equal to or less than the core priority order threshold value 2413, as the core number “3”, is stored, the core number is stored in a portion of the core number queue 2302 in which core numbers are aligned in conformity with the core priority order.

On the other hand, when a core number whose core priority order is higher than the core priority order threshold value 2413, as the core number “5”, is stored, the core number is stored in the tail of a portion in which core numbers are aligned on a first come, first served basis in the core number queue 2302.

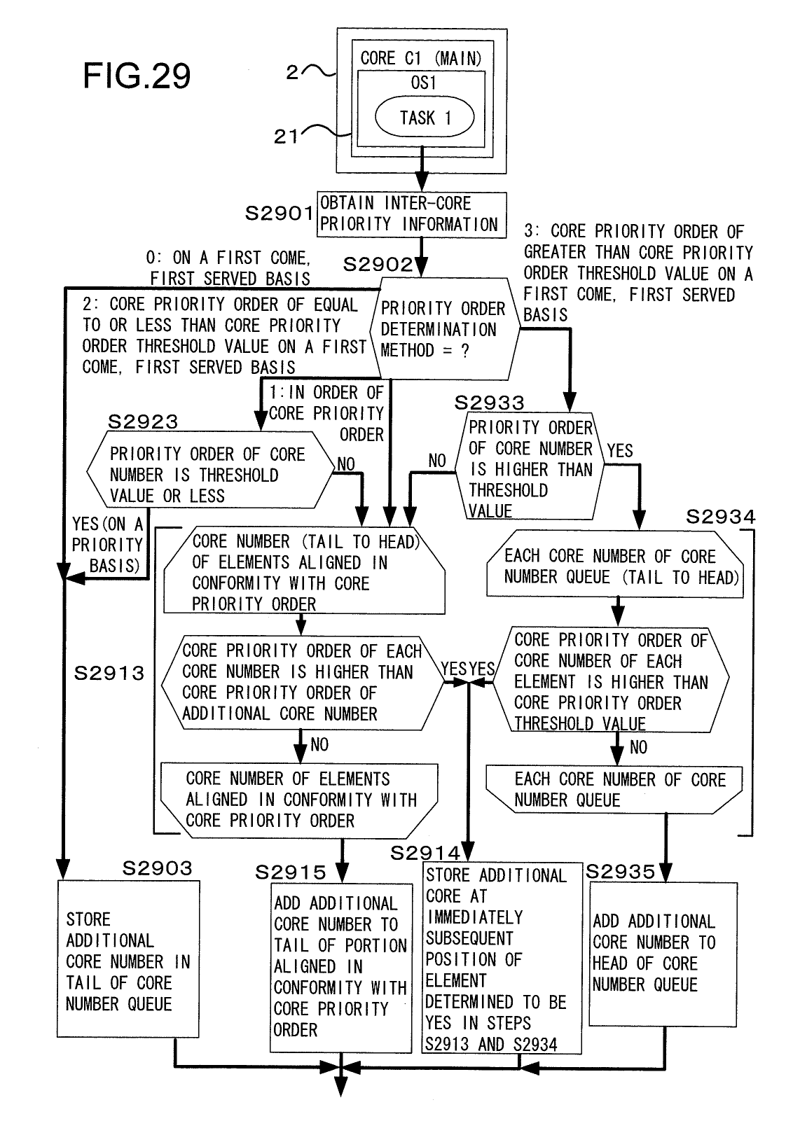

FIG. 29 shows process flow relating to a method to store the core number (referred to as an additional core number) of a core on which the resource acquisition function 903 has been executed in the core number queue 6102 in the step S1503 of FIG. 15 and FIG. 17.

In a step S2901 of FIG. 29, the task 1 obtains the inter-core priority information 6103.

In a step S2902, if the waiting order determination method 61031 included in the inter-core priority information 6103 is 0 (on a first come, first served basis), the flow of control proceeds to a step S2903. If the waiting order determination method 61031 is 1 (in order of core priority), the flow of control proceeds to a step S2913. If the waiting order determination method 61031 is 2 (those with a core priority order of equal to or less than the core priority order threshold value are on a first come, first served basis), the flow of control proceeds to a step S2923. If the waiting order determination method 61031 is 3 (those with a core priority order higher than the core priority order threshold value are on a first come, first served basis), the flow of control proceeds to a step S2933.

In the step S2903, the task 1 stores the core number in the tail of the core number queue 6102. After that, the processing of FIG. 29 is finished.

In the step S2913, the task 1 searches elements (FIG. 26 to FIG. 28) of the portion in which core numbers are aligned in conformity with the core priority order in the core number queue 6102 for one whose core priority order is higher than that of the additional core number. The search is executed in order from the tail to the head of the core number queue 6102. If a core number whose core priority order is higher than that of the additional core number has not been searched, the flow of control proceeds to a step S2915. If there is one, the flow of control proceeds to a step S2914.

In the step S2914, the task 1 stores the additional core number in the immediately subsequent position of the core number searched in the step S2913. On the other hand, in the step S2915, the additional core number is added in the tail of the portion in which core numbers are aligned in conformity with the core priority order.

In the step S2923, the task 1 makes a decision as to whether or not the core priority order of the additional core number is lower than the core priority order threshold value 61033. If lower than the core priority order threshold value 61033, the flow of control proceeds to the step S2903. If not so, the flow of control transitions to the step S2913.

In the step S2933, the task 1 makes a decision as to whether or not the core priority order of the additional core number is higher than the core priority order threshold value 61033. If it is higher than the core priority order threshold value 61033, the flow of control proceeds to a step S2934. If not so, the flow of control proceeds to the step S2913.

In the step S2934, the task 1 makes a decision as to whether or not the core priority order of the core number included in the core number queue 6102 is higher than the core priority order threshold value 61033 and searches the tail of the portion in which core numbers are aligned on a first come, first served basis in the core number queue 6102. The search is executed in order from the tail to the head of the core number queue 6102. If a decision is made in the step S2934 that the core priority order of the core number is higher than the core priority order threshold value 61033, the flow of control proceeds to the step S2914. On the other hand, if the core priority order of all the core numbers is lower than the core priority order threshold value 61033, there is no element stored in the core number queue 6102 on a first come, first served basis, and thus the flow of control transitions to a step S2935, so that the additional core number is stored in the head of the core number queue 6102.

[Comparison with Prior Arts and Operations and Effects]

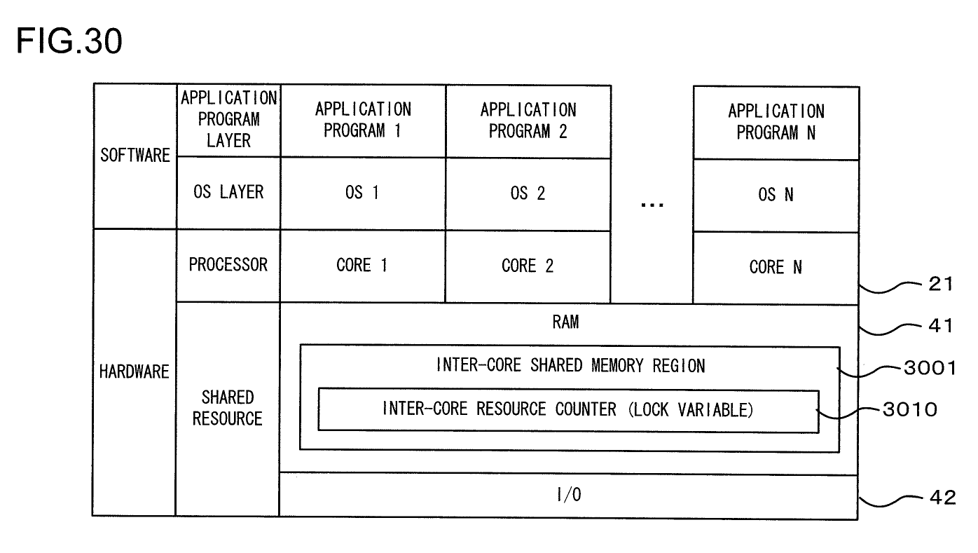

Exclusive control relating to an inter-core shared resource has conventionally been performed in a structure as shown in FIG. 30. In the exclusive control method in the structure of FIG. 30, an inter-core resource counter 3010 is stored as a lock variable in an inter-core shared memory region 3001, and each task sets and reads this lock variable so as to perform the exclusive control.

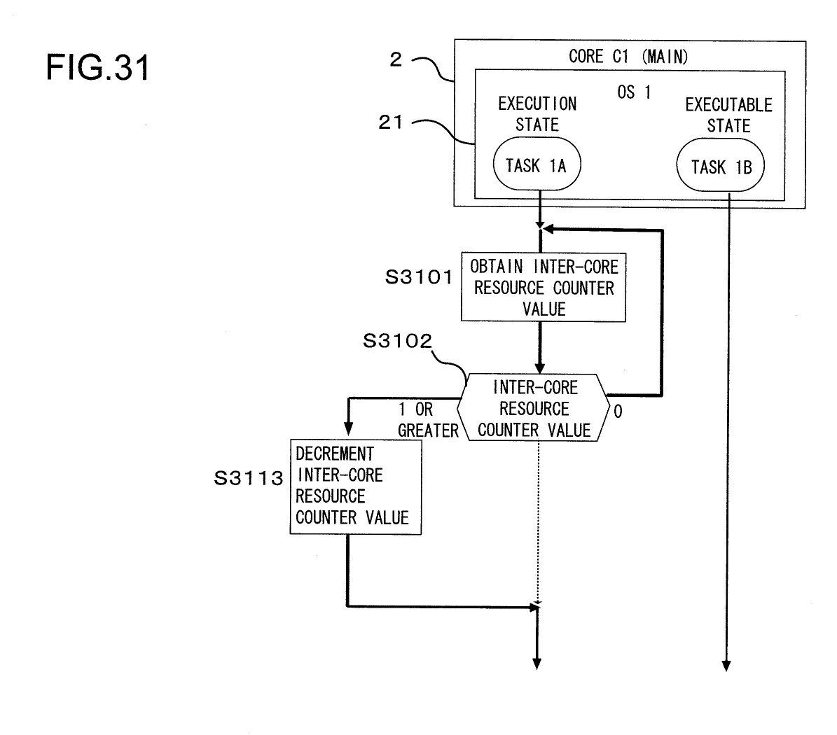

Then, resource acquisition has conventionally been performed by the process flow shown in FIG. 31 using the structure of FIG. 30. In a step S3101 of FIG. 31, the task 1A reads the value of the inter-core resource counter 3010. Then, the flow of control transitions to a step S3102 and, if the value of the inter-core resource counter 3010 is 1 or greater, transitions to a step S3103, so that the inter-core resource counter 3010 value is decremented as in the present embodiment. On the other hand, if the value of the inter-core resource counter 3010 is 0, the flow of control loops until the value of the inter-core resource counter 3010 becomes 1, and the task 1A waits in the step S3102. For this reason, while the task 1A is waiting in the step S3102, the task 1B in the executable state does not transition to the execution state. Thus, since in conventional processing to acquire an inter-core shared resource, acquisition of an inter-core shared resource is waited in a loop, another task can not be executed.

On the contrary, the present embodiment includes the inter-core resource management information 610 including the inter-core resource counter 6100 indicating the remaining number of inter-core shared resources, the semaphore 6101 of each OS, and the core number queue 6102, obtains the value of the inter-core resource counter 6100 (the step S1501 of FIG. 15), and makes a decision as to whether or not the inter-core shared resource can be acquired based upon the obtained value of the inter-core resource counter 6100 (the step S1502). If a decision is made that the inter-core shared resource can be acquired, the value of the inter-core resource counter 6100 is decremented (the step S1513). If a decision is made that the inter-core shared resource can not be acquired, the core number is stored in the core number queue 6102 (the step S1503) and the task is set in the waiting state (the steps S1504 to S1505). Thus, when an inter-core shared resource was not able to be acquired, a decision is made immediately based upon the inter-core resource management information 610 and the OS sets the task in the waiting state, and therefore another task can be executed (FIG. 15), and if there is no other task in the executable state, the cores 21 can be set in the power saving mode (FIG. 17). Consequently, the present embodiment can improve processing efficiency of the overall computer and reduce power consumption compared with prior arts.

[Variations]

The above embodiment may be varied as follows.

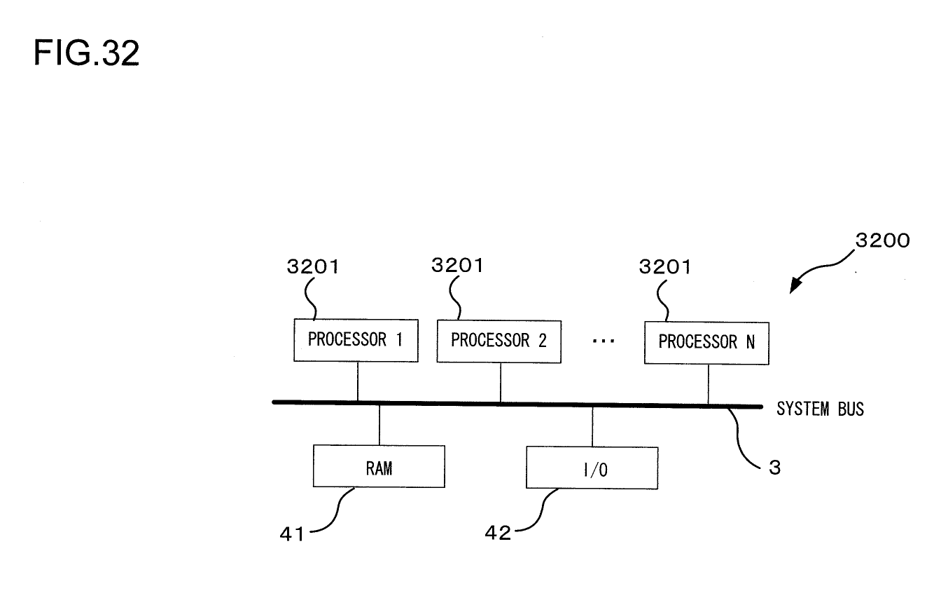

While the computer system 1 in the above embodiment uses the multi-core processor 2, a plurality of processors may be adopted. FIG. 32 shows another example of the hardware configuration of the computer system in the present embodiment. In FIG. 32, the multi-core processor 2 of FIG. 1 is replaced by a plurality of processors 3201 connected to the system bus. Even if a multi-core processor is thus replaced by a multiprocessor, multi-core processors themselves are of a subset of the set of tightly-coupled multiprocessors in the sense that the RAM 41 and the I/O 42, which are resources, are shared by each of the cores 3201. Therefore, if there is an inter-processor interrupt function in place of the inter-core interrupt function, the inter-core exclusive control of the present invention can be achieved.

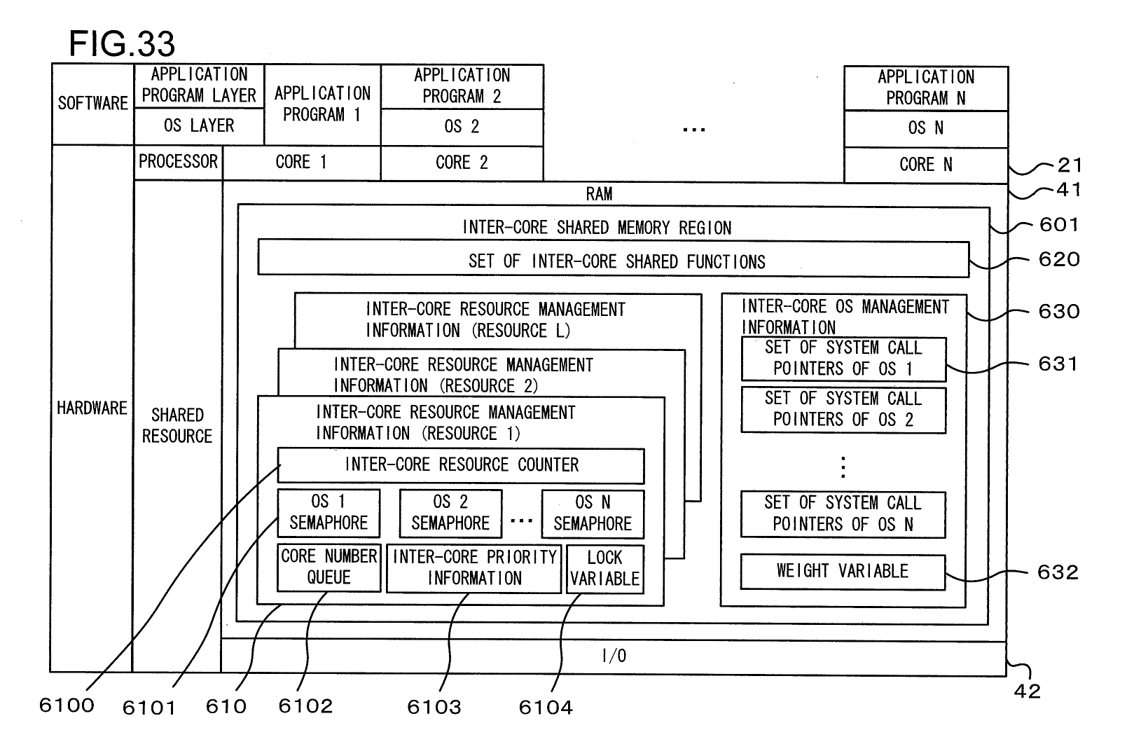

FIG. 33 shows another example of hierarchies of hardware and software in the present embodiment. The present embodiment includes some cores provided with OSs so that an application program runs on each of the OSs and other cores 3201 on which an application program runs without any OS. Even if an OS runs on at least one of the cores 3201 as FIG. 32, when the core 3201 on which the OS runs waits for acquisition of an inter-core shared resource, the task switching function or the power saving function of the OS can improve the system efficiency and reduce power consumption.

The embodiments explained above may be applied to, for instance, navigation devices. For example, the cores 21 are allocated to each function of navigation devices such as a route search function, a map matching function, a 2D/3D mapping function, a vehicle guidance function, and a facility search function, and each of them can be applied to exclusive control to acquire the RAM 41 and the I/O 42 such as a display monitor.

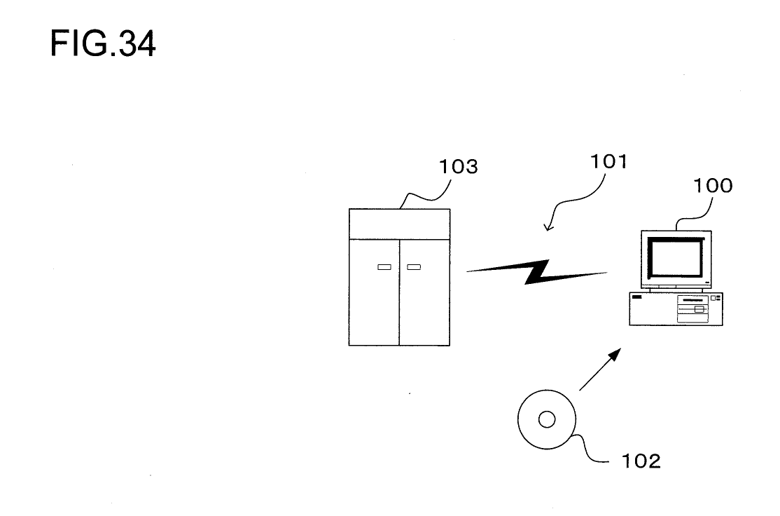

It is to be noted that a program to achieve processing by the OS and application program in the embodiments described above can be provided to a computer system through a recording medium such as a CD-ROM and an electric telecommunication line such as the Internet. FIG. 34 is an illustration showing such provision. A personal computer 100 is provided with a program through a CD-ROM 102. In addition, the personal computer 100 includes a connection function with a telecommunication line 101 so as to be provided with the program from a server 103. The telecommunication line 101 is the Internet, a telecommunication line such as a personal computer communication, a leased telecommunication line, or the like. The server 103 transmits a program to the personal computer 100 through the telecommunication line 101. In other words, the server 103 converts the program into a data signal on a carrier wave and transmits it through the telecommunication line 101. Thus, the program can be supplied as a computer-readable computer program product in a variety of forms such as a recording medium and a carrier wave.

The embodiments and variations described above are examples, and the present invention is not limited to the embodiments and variations described above, as long as the features characterizing the invention remain intact.

1. A computer system, comprising:
a plurality of processors each executing an individual OS;
a shared resource being used by the plurality of processors; and
a storage unit in which management information corresponding to the shared resource is stored, wherein:
the management information includes:
a semaphore for each OS managing a task which runs on the plurality of processors;
a queue in which information for specifying a processor which has requested acquisition of the shared resource is stored in series; and
a resource counter indicating a remaining number of the shared resources which can be acquired, wherein:
each of the plurality of processors includes:
a counter obtaining section that obtains a value of the resource counter included in the management information corresponding to the shared resource to be acquired for processing the task;
an acquisition decision-making section that makes a decision as to whether or not the shared resource can be acquired based upon the value of the resource counter obtained by the counter obtaining section; and
a resource acquiring section that acquires the shared resource and decrements the value of the resource counter of the corresponding management information if the acquisition decision-making section makes a decision that the shared resource can be acquired, and that stores information for specifying the processor in the queue of the management information corresponding to the shared resource and sets a task to be processed by the processor in a waiting state if the acquisition decision-making section makes a decision that the shared resource can not be acquired.

2. A computer system according to claim 1, wherein:
each of the plurality of processors further includes:
an empty queue decision-making section that makes a decision as to whether or not the queue of the shared resource is empty upon releasing the shared resource having been acquired; and
a resource releasing section that increments the value of the resource counter of the shared resource and releases the shared resource if the empty queue decision-making section makes a decision that the queue of the shared resource is empty, and that causes a processor to be specified by the information stored in the queue to acquire the shared resource and sets a task on the processor in an execution state if the empty queue decision-making section makes a decision that the queue of the shared resource is not empty.

3. A computer system according to claim 1, wherein:
at least one of the plurality of processors further includes:
a management information generating section that generates the management information; and
a management information storage section that stores the management information generated by the management information generating section in the storage unit.

4. A computer system according to claim 2, wherein:
at least one of the plurality of processors further includes:
a management information generating section that generates the management information; and
a management information storage section that stores the management information generated by the management information generating section in the storage unit, wherein:
the management information generating section generates the management information in which a semaphore counter included in the semaphore for each OS is set to zero; and
if a decision is made that the queue is not empty, the resource releasing section increments a semaphore counter corresponding to a processor to be specified by the information stored in the queue so as to cause the processor to acquire the shared resource and sets a task on the processor in an execution state.

5. A computer system according to claim 1, wherein:
the management information further includes a lock variable;
each of the plurality of processors further includes a lock decision-making section that makes a decision as to whether or not the management information can be read based upon the lock variable when obtaining the management information from the storage unit; and
the counter obtaining section obtains the value of the resource counter included in the management information when the lock decision-making section makes a decision that the management information can be read.

6. A computer system according to claim 2, wherein:
the management information further includes a lock variable;
each of the plurality of processors further includes a lock decision-making section that makes a decision as to whether or not the management information can be read based upon the lock variable when obtaining the management information from the storage unit; and
the empty queue decision-making section makes a decision as to whether or not the queue is empty in the management information corresponding to the shared resource acquired by the resource acquiring section when the lock decision-making section makes a decision that the management information can be read.

7. A computer system according to claim 1, wherein:
the management information further includes priority order information that defines for each processor a priority order to acquire the shared resource and waiting order determination method information that defines a method for the resource acquiring section to store the information in the queue; and
the resource acquiring section makes a decision on a position in the queue in which the information is stored based upon the waiting order determination method information and the priority order information.

8. A computer system according to claim 7, wherein:
the resource acquiring section stores the information in the queue on a first come, first served basis or in order according to the priority order based upon the waiting order determination method information and the priority order information.

9. A computer system according to claim 7, wherein:
the management information further includes a predetermined priority order threshold value; and
the resource acquiring section makes a decision on a position in the queue in which the information is stored based upon the waiting order determination method information, the priority order information, and the priority order threshold value.

10. A computer system according to claim 9, wherein:
the resource acquiring section stores the information in the queue on a first come, first served basis or in order according to the priority order based upon the waiting order determination method information, the priority order information, and the priority order threshold value.

11. A computer system according to claim 1, wherein:
the storage unit further stores an OS system call being commonly accessible among the plurality of processors and a memory address indicating a position of the OS system call; and
the processor executes the OS system call based upon the memory address.

12. A program product having a program to cause, when executed by any one of the plurality of processors of the computer system according to claim 1, the one of the plurality of processors to function as the counter obtaining section, the acquisition decision-making section, and the resource acquiring section.

13. A program product having a program to cause, when executed by any one of the plurality of processors of the computer system according to claim 2, the one of the plurality of processors to function as the counter obtaining section, the acquisition decision-making section, the resource acquiring section, the empty queue decision-making section, and the resource releasing section.

14. A program product having a program to cause, when executed by any one of the plurality of processors of the computer system according to claim 3, the one of the plurality of processors to function as the counter obtaining section, the acquisition decision-making section, the resource acquiring section, the management information generating section, and the management information storage section.
